(19) United States
(12) Patent Application Publication
(10) Pub. No.: US 2015/0099845 A1
(43) Pub. Date: Apr. 9, 2015

(54) FLAME RETARDANT THERMOPLASTIC COMPOSITIONS WITH IMPROVED PROPERTIES

(71) Applicant: SABIC Innovative Plastics IP B.V., Bergen Op Zoom (NL)

(72) Inventors: Vikram K. Daga, Evansville, IN (US); Amit S. Kulkarni, Evansville, IN (US)

(73) Assignee: SABIC Innovative Plastics IP B.V., Bergen Op Zoom (NL)

(21) Appl. No.: 14/047,612

(22) Filed: Oct. 7, 2013

(51) Int. Cl. C08L 69/00

(52) U.S. Cl. CPC C08L 69/00
USPC 524/506; 525/105

(57) ABSTRACT

Disclosed herein are blended thermoplastic compositions comprising at least one polycarbonate component, at least one impact modifier component, and at least one flame retardant component. The resulting flame retardant compositions can be used in the manufacture of articles requiring materials with high impact strength and ductility, good flow, thin wall flame retardancy and good thermal resistance. This abstract is intended as a scanning tool for purposes of searching in the particular art and is not intended to be limiting of the present invention.

### FIELD OF INVENTION

The present invention relates to blended thermoplastic compositions comprising at least one polycarbonate component, at least one impact modifier, and at least one flame retardant. The resulting flame retardant compositions can be used in the manufacture of articles having, among other characteristics, improved impact properties and increased heat deflection temperature.

### BACKGROUND OF THE INVENTION

Polycarbonates (PC) are synthetic thermoplastic resins that can, for example, be derived from bisphenols and phosgene, or their derivatives. Polycarbonates are a useful class of polymers having many desired properties. They are useful for forming a wide variety of products, such as by molding, extrusion, and thermoforming processes. Impact modified polycarbonate blend systems are widely used engineering thermoplastics in various applications owing to the combination of their properties such as impact strength, flow and thermal resistance.

Specifically, flame retardant versions of impact modified polycarbonate blends have seen substantial commercial growth in the last decade in electrical and electronic equipment housing applications. Resorcinol diphenyl phosphate (RDP) and bisphenol A bis(diphenyl phosphate) (BPADP) are known to be effective flame suppressants for impact modified PC and are employed extensively as halogen-free liquid flame retardants in flame-retardant grades of impact modified polycarbonates. However, these flame retardants also tend to adversely affect other key properties such as impact strength and heat deflection temperature (HDT). This poses a limit on the use of such flame retardants grades in applications requiring a good flame performance along with superior impact and HDT, two key physical properties.

Moreover, the continued trend in miniaturization of components requires molding of articles that utilize thinner walls and that are increasingly more geometrically intricate. This requires sufficient melt flow of the formulations which can be a challenge to achieve in conjunction with the other required properties. One advantage of liquid flame retardants is an improved flow but with loss in impact strength and HDT. Although use of certain solid flame retardants has been found to enhance the impact strength and HDT as compared to liquid flame retardant containing formulations, these enchanced properties comes with a loss in melt flow.

Thus, there remains a continuing need in the art for flame retardant polycarbonate compositions that can readily produce articles having improved physical properties, such as impact strength and ductility, while maintaining or improving melt flow performance. These needs and other needs are met by the various aspects of the present invention.

### SUMMARY OF THE INVENTION

The present invention relates to blended thermoplastic compositions comprising at least one polycarbonate component, at least one impact modifier, and at least one flame retardant comprising an oligomeric phosphate ester. The resulting compositions can be used in the manufacture of articles requiring materials with high impact strength and ductility, good flow, thin wall flame retardancy and good thermal resistance.

In one aspect, the invention relates to a blended thermoplastic composition comprising: a) from about 30 wt % to about 90 wt % of a polycarbonate component comprising at least one bisphenol A polycarbonate and at least one polycarbonate-polysiloxane copolymer; b) from greater than about 0 wt % to about 15 wt % of an impact modifier component; and c) from about 5 wt % to about 15 wt % of a flame retardant component comprising an oligomeric phosphate ester, wherein the oligomeric phosphate ester is a free flowing powder at 23° C.; wherein the combined weight percent value of all components does not exceed about 100 wt %; and wherein all weight percent values are based on the total weight of the composition.

In various further aspects, the invention relates to articles comprising the disclosed compositions.

In a further aspect, the invention relates to methods of making the disclosed compositions.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE INVENTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

### DEFINITIONS

It is also to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polycarbonate” includes mixtures of two or more polycarbonate polymers.

As used herein, the term “combination” is inclusive of blends, mixtures, alloys, reaction products, and the like.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally substituted alkyl” means that the alkyl group can or cannot be substituted and that the description includes both substituted and unsubstituted alkyl groups.

As used herein, the term “effective amount” refers to an amount that is sufficient to achieve the desired modification of a physical property of the composition or material. For example, an “effective amount” of a oligomeric phosphate ester flame retardant refers to an amount that is sufficient to achieve the desired flame performance, e.g. achieving the desired flame retardancy rating. The specific level in terms of wt % in a composition required as an effective amount will depend upon a variety of factors including the amount and type of polycarbonate, amount and type of impact modifer component, and end use of the article made using the composition.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C—F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

As used herein the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

Compounds are described using standard nomenclature. For example, any position not substituted by any indicated group is understood to have its valence filled by a bond as indicated, or a hydrogen atom. A dash (“-”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this invention belongs.

The term “alkyl group” as used herein is a branched or unbranched saturated hydrocarbon group of 1 to 24 carbon atoms, such as methyl, ethyl, n propyl, isopropyl, n butyl, isobutyl, t butyl, pentyl, hexyl, heptyl, octyl, decyl, tetradecyl, hexadecyl, eicosyl, tetracosyl and the like. A “lower alkyl” group is an alkyl group containing from one to six carbon atoms.

The term “aryl group” as used herein is any carbon-based aromatic group including, but not limited to, benzene, naphthalene, etc. The term “aromatic” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “aralkyl” as used herein is an aryl group having an alkyl, alkynyl, or alkenyl group as defined above attached to the aromatic group. An example of an aralkyl group is a benzyl group.

The term “carbonate group” as used herein is represented by the formula OC(O)OR, where R can be hydrogen, an alkyl, alkenyl, alkynyl, aryl, aralkyl, cycloalkyl, halogenated alkyl, or heterocycloalkyl group described above.

The term “organic residue” defines a carbon containing residue, i.e., a residue comprising at least one carbon atom, and includes but is not limited to the carbon-containing groups, residues, or radicals defined hereinabove. Organic residues can contain various heteroatoms, or be bonded to another molecule through a heteroatom, including oxygen, nitrogen, sulfur, phosphorus, or the like. Examples of organic residues include but are not limited alkyl or substituted alkyls, alkoxy or substituted alkoxy, mono or di-substituted amino, amide groups, etc. Organic residues can preferably comprise 1 to 18 carbon atoms, 1 to 15, carbon atoms, 1 to 12 carbon atoms, 1 to 8 carbon atoms, 1 to 6 carbon atoms, or 1 to 4 carbon atoms. In a further aspect, an organic residue can comprise 2 to 18 carbon atoms, 2 to 15, carbon atoms, 2 to 12 carbon atoms, 2 to 8 carbon atoms, 2 to 4 carbon atoms, or 2 to 4 carbon atoms.

A very close synonym of the term “residue” is the term “radical,” which as used in the specification and concluding claims, refers to a fragment, group, or substructure of a molecule described herein, regardless of how the molecule is prepared. For example, a 2,4-dihydroxyphenyl radical in a particular compound has the structure:

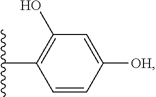 [SMILES: *c1ccc(O)cc1O]

regardless of whether 2,4-dihydroxyphenyl is used to prepare the compound. In some embodiments the radical (for example an alkyl) can be further modified (i.e., substituted alkyl) by having bonded thereto one or more “substituent radicals.” The number of atoms in a given radical is not critical to the present invention unless it is indicated to the contrary elsewhere herein.

“Organic radicals,” as the term is defined and used herein, contain one or more carbon atoms. An organic radical can have, for example, 1-26 carbon atoms, 1-18 carbon atoms, 1-12 carbon atoms, 1-8 carbon atoms, 1-6 carbon atoms, or 1-4 carbon atoms. In a further aspect, an organic radical can have 2-26 carbon atoms, 2-18 carbon atoms, 2-12 carbon atoms, 2-8 carbon atoms, 2-6 carbon atoms, or 2-4 carbon atoms. Organic radicals often have hydrogen bound to at least some of the carbon atoms of the organic radical. One example, of an organic radical that comprises no inorganic atoms is a 5,6,7,8-tetrahydro-2-naphthyl radical. In some embodiments, an organic radical can contain 1-10 inorganic heteroatoms bound thereto or therein, including halogens, oxygen, sulfur, nitrogen, phosphorus, and the like. Examples of organic radicals include but are not limited to an alkyl, substituted alkyl, cycloalkyl, substituted cycloalkyl, mono-substituted amino, di-substituted amino, acyloxy, cyano, carboxy, carboalkoxy, alkylcarboxamide, substituted alkylcarboxamide, dialkylcarboxamide, substituted dialkylcarboxamide, alkylsulfonyl, alkylsulfinyl, thioalkyl, thiohaloalkyl, alkoxy, substituted alkoxy, haloalkyl, haloalkoxy, aryl, substituted aryl, heteroaryl, heterocyclic, or substituted heterocyclic radicals, wherein the terms are defined elsewhere herein. A few non-limiting examples of organic radicals that include heteroatoms include alkoxy radicals, trifluoromethoxy radicals, acetoxy radicals, dimethylamino radicals and the like.

As used herein, the terms “number average molecular weight” or “Mₙ” can be used interchangeably, and refer to the statistical average molecular weight of all the polymer chains in the sample and is defined by the formula:

$${M}_{n} = \frac{Σ {N}_{i} {M}_{i}}{Σ {N}_{i}} ,$$

where Mᵢ is the molecular weight of a chain and Nᵢ is the number of chains of that molecular weight. Mₙ can be determined for polymers, e.g., polycarbonate polymers, by methods well known to a person having ordinary skill in the art using molecular weight standards, e.g. polycarbonate standards or polystyrene standards, preferably certified or traceable molecular weight standards.

As used herein, the terms “weight average molecular weight” or “Mw” can be used interchangeably, and are defined by the formula:

$${M}_{w} = \frac{Σ {N}_{i} {M}_{i}^{2}}{Σ {N}_{i} {M}_{i}} ,$$

where Mᵢ is the molecular weight of a chain and Nᵢ is the number of chains of that molecular weight. Compared to Mₙ, M_{w} takes into account the molecular weight of a given chain in determining contributions to the molecular weight average. Thus, the greater the molecular weight of a given chain, the more the chain contributes to the Mₙ. M_{w} can be determined for polymers, e.g. polycarbonate polymers, by methods well known to a person having ordinary skill in the art using molecular weight standards, e.g. polycarbonate standards or polystyrene standards, preferably certified or traceable molecular weight standards.

As used herein, the terms “polydispersity index” or “PDI” can be used interchangeably, and are defined by the formula:

$$PDI = \frac{{M}_{w}}{{M}_{n}} .$$

The PDI has a value equal to or greater than 1, but as the polymer chains approach uniform chain length, the PDI approaches unity.

The terms “BisA,” “BPA,” or “bisphenol A,” which can be used interchangeably, as used herein refers to a compound having a structure represented by the formula:

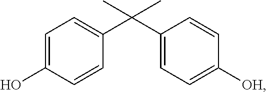 [SMILES: CC(C)(c1ccc(O)cc1)c1ccc(O)cc1]

BisA can also be referred to by the name 4,4′-(propane-2,2-diyl)diphenol; p,p′-isopropylidenebisphenol; or 2,2-bis(4-hydroxyphenyl)propane. BisA has the CAS #80-05-7.

As used herein, “polycarbonate” refers to an oligomer or polymer comprising residues of one or more dihydroxy compounds, e.g., dihydroxy aromatic compounds, joined by carbonate linkages; it also encompasses homopolycarbonates, copolycarbonates, and (co)polyester carbonates.

The terms “residues” and “structural units”, used in reference to the constituents of the polymers, are synonymous throughout the specification.

As used herein the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### Blended Thermoplastic Polymer Compositions

As briefly described above, the present invention relates to blended thermoplastic compositions comprising at least one polycarbonate component, at least one impact modifier, and at least one flame retardant. The resulting compositions can be used in the manufacture of articles requiring materials with high modulus and ductility, good flow, thin wall flame retardancy and good thermal resistance.

In one aspect, the invention relates to blended thermoplastic compositions comprising: a) from about 30 wt % to about 90 wt % of a polycarbonate component comprising at least one bisphenol A polycarbonate and at least one polycarbonate-polysiloxane copolymer; b) from greater than about 0 wt % to about 15 wt % of an impact modifier component; and c) from about 5 wt % to about 15 wt % of a flame retardant component comprising an oligomeric phosphate ester, wherein the oligomeric phosphate ester is a free flowing powder at 23° C.; wherein the combined weight percent value of all components does not exceed about 100 wt %; and wherein all weight percent values are based on the total weight of the composition.

In another aspect, the invention relates to a blended thermoplastic composition comprising: a) from about 60 wt % to about 90 wt % of a polycarbonate component comprising at least one bisphenol A polycarbonate and at least one polycarbonate-polysiloxane copolymer; b) from about 1 wt % to about 20 wt % of an impact modifier component; and c) from about 5 wt % to about 12 wt % of a flame retardant component comprising an oligomeric phosphate ester, wherein the oligomeric phosphate ester is a free flowing powder at 23° C.; wherein the combined weight percent value of all components does not exceed about 100 wt %; and wherein all weight percent values are based on the total weight of the composition.

In another aspect, the invention relates to a blended thermoplastic composition comprising: a) from about 60 wt % to about 90 wt % of a polycarbonate component comprising at least one bisphenol A polycarbonate and at least one polycarbonate-polysiloxane copolymer; b) from about 1 wt % to about 5 wt % of an impact modifier component comprising at least one methyl methacrylate-butadiene-styrene (MBS) polymer component; and c) from about 5 wt % to about 12 wt % of a flame retardant component comprising an oligomeric phosphate ester, wherein the oligomeric phosphate ester is a free flowing powder at 23° C.; wherein the combined weight percent value of all components does not exceed about 100 wt %; and wherein all weight percent values are based on the total weight of the composition.

In another aspect, the invention relates to a blended thermoplastic composition comprising: a) from about 60 wt % to about 90 wt % of a polycarbonate component comprising at least one bisphenol A polycarbonate and at least one polycarbonate-polysiloxane copolymer; b) from about 1 wt % to about 5 wt % of an impact modifier component comprising at least one methyl methacrylate-butadiene (MB) polymer component; and c) from about 5 wt % to about 12 wt % of a flame retardant component comprising an oligomeric phosphate ester, wherein the oligomeric phosphate ester is a free flowing powder at 23° C.; wherein the combined weight percent value of all components does not exceed about 100 wt %; and wherein all weight percent values are based on the total weight of the composition.

In another aspect, the invention relates to a blended thermoplastic composition comprising: a) from about 60 wt % to about 90 wt % of a polycarbonate component comprising at least one bisphenol A polycarbonate and at least one polycarbonate-polysiloxane copolymer; b) from about 1 wt % to about 10 wt % of an impact modifier component; and c) from about 6 wt % to about 11 wt % of a flame retardant component comprising an oligomeric phosphate ester, wherein the oligomeric phosphate ester is a free flowing powder at 23° C.; wherein the combined weight percent value of all components does not exceed about 100 wt %; and wherein all weight percent values are based on the total weight of the composition.

In another aspect, the invention relates to a blended thermoplastic composition comprising: a) from about 40 wt % to about 60 wt % of a first polycarbonate component;

wherein the first polycarbonate polymer component has a melt flow rate (MFR) from about 20 grams/10 minutes to about 30 grams/10 minutes when measured at 300° C. and under a load of 1.2 kg according to ASTM D1238; and wherein the first polycarbonate polymer component has a weight average molecular weight from about 18,000 to about 25,000 grams/mole, as measured by gel permeation chromatography using BPA polycarbonate standards; b) from about 10 wt % to about 40 wt % of a second polycarbonate component; wherein the second polycarbonate polymer component has a melt flow rate (MFR) from about 4.0 grams/10 minutes to about 10.0 grams/10 minutes when measured at 300° C. and under a load of 1.2 kg according to ASTM D1238; and wherein the second polycarbonate polymer component has a weight average molecular weight from about 25,000 to about 30,000 grams/mole, as measured by gel permeation chromatography using BPA polycarbonate standards; c) from about 5 wt % to about 20 wt % of a third polycarbonate component; wherein the third polycarbonate component is a polycarbonate-polysiloxane copolymer; wherein the third polycarbonate component comprises a polysiloxane block from about 5 wt % to about 30 wt % of the polycarbonate-polysiloxane copolymer; d) from greater than about 0 wt % to about 10 wt % of an impact modifier component; and e) from about 5 wt % to about 15 wt % of a flame retardant component comprising an oligomeric phosphate ester; wherein the oligomeric phosphate ester is a free flowing powder at 23° C.; wherein the combined weight percent value of all components does not exceed about 100 wt %; and wherein all weight percent values are based on the total weight of the composition.

In another aspect, the invention relates to a blended thermoplastic composition comprising: a) from about 30 wt % to about 90 wt % of a polycarbonate component comprising at least one bisphenol A polycarbonate and at least one polycarbonate-polysiloxane copolymer; b) from greater than about 0 wt % to about 20 wt % of an impact modifier component comprising at least one methyl methacrylate-butadiene-styrene (MBS) polymer component; and c) from about 5 wt % to about 15 wt % of a flame retardant component comprising an oligomeric phosphate ester, wherein the oligomeric phosphate ester is a free flowing powder at 23° C.; wherein the combined weight percent value of all components does not exceed about 100 wt %; wherein all weight percent values are based on the total weight of the composition; wherein a molded sample comprising the blended thermoplastic composition has a notched Izod impact strength of at least about 500 J/m when tested in accordance with ASTM D256 at −20° C.; wherein a molded sample comprising the blended thermoplastic composition has 100% ductility notched Izod impact strength when tested in accordance with ASTM D256 at −20° C.; and wherein a molded sample comprising the blended thermoplastic composition has a p(FTP) value of at least about 0.9.

In another aspect, the invention relates to a blended thermoplastic composition comprising: a) from about 30 wt % to about 90 wt % of a polycarbonate component comprising at least one bisphenol A polycarbonate and at least one polycarbonate-polysiloxane copolymer; b) from greater than about 0 wt % to about 20 wt % of an impact modifier component comprising at least one methyl methacrylate-butadiene (MB) polymer component; and c) from about 5 wt % to about 15 wt % of a flame retardant component comprising an oligomeric phosphate ester, wherein the oligomeric phosphate ester is a free flowing powder at 23° C.; wherein the combined weight percent value of all components does not exceed about 100 wt %; wherein all weight percent values are based on the total weight of the composition; wherein a molded sample comprising the blended thermoplastic composition has a notched Izod impact strength of at least about 500 J/m when tested in accordance with ASTM D256 at −20° C.; wherein a molded sample comprising the blended thermoplastic composition has 100% ductility notched Izod impact strength when tested in accordance with ASTM D256 at −20° C.; and wherein a molded sample comprising the blended thermoplastic composition has a p(FTP) value of at least about 0.9.

In various aspects, molded samples may comprise the disclosed blended thermoplastic compositions. In a further aspect, the molded sample comprising the blended thermoplastic composition has a notched Izod impact strength greater than or equal to about 150 J/m when tested in accordance with ASTM D256. In a still further aspect, the molded sample comprising the blended thermoplastic composition has a notched Izod impact strength greater than or equal to about 250 J/m when tested in accordance with ASTM D256. In yet a further aspect, the molded sample comprising the blended thermoplastic composition has a notched Izod impact strength of from about 150 J/m to about 900 J/m when tested in accordance with ASTM D256. In an even further aspect, the molded sample comprising the blended thermoplastic composition has a notched Izod impact strength of from about 200 J/m to about 850 J/m when tested in accordance with ASTM D256. In a still further aspect, the molded sample comprising the blended thermoplastic composition has a notched Izod impact strength of from about 200 J/m to about 800 J/m when tested in accordance with ASTM D256. In yet a further aspect, the molded sample comprising the blended thermoplastic composition has a notched Izod impact strength of from about 250 J/m to about 750 J/m when tested in accordance with ASTM D256.

In a further aspect, the molded sample comprising the blended thermoplastic composition has a notched Izod impact strength of at least about 150 J/m when tested in accordance with ASTM D256 at −20° C. In a still further aspect, the molded sample comprising the blended thermoplastic composition has a notched Izod impact strength of at least about 250 J/m when tested in accordance with ASTM D256 at −20° C. In yet a further aspect, the molded sample comprising the blended thermoplastic composition has a notched Izod impact strength of at least about 350 J/m when tested in accordance with ASTM D256 at −20° C. In an even further aspect, the molded sample comprising the blended thermoplastic composition has a notched Izod impact strength of at least about 400 J/m when tested in accordance with ASTM D256 at −20° C. In a still further aspect, the molded sample comprising the blended thermoplastic composition has a notched Izod impact strength of at least about 500 J/m when tested in accordance with ASTM D256 at −20° C. In yet a further aspect, the molded sample comprising the blended thermoplastic composition has a notched Izod impact strength of at least about 550 J/m when tested in accordance with ASTM D256 at −20° C.

In a further aspect, a sufficient amount of the solid oligomeric phosphate ester flame retardant is employed in place of a liquid flame retardant to maintain the flame performance while improving and/or maintaining physical properties of the composition, such as impact strength and/or heat deflection temperature (HDT). For example, according to aspects of the disclosure, a molded sample comprising the blended thermoplastic composition has a p(FTP) value of at least about 0.80, and a notched Izod impact strength of at least about 350 J/m when tested in accordance with ASTM D256 at −20° C. In a further aspect, a molded sample comprising the blended thermoplastic composition has a p(FTP) value of at least about 0.90, and a notched Izod impact strength of at least about 350 J/m when tested in accordance with ASTM D256 at −20° C. In a still further aspect, a molded sample comprising the blended thermoplastic composition has a p(FTP) value of at least about 0.90, and a notched Izod impact strength of at least about 400 J/m when tested in accordance with ASTM D256 at −20° C. In an even further aspect, a molded sample comprising the blended thermoplastic composition has a p(FTP) value of at least about 0.90, and a notched Izod impact strength of at least about 450 J/m when tested in accordance with ASTM D256 at −20° C.

In some aspects, the molded sample comprising the blended thermoplastic composition has greater than 0% ductility notched Izod impact strength when tested in accordance with ASTM D256 at 0° C. In a still further aspect, the molded sample comprising the blended thermoplastic composition has at least 20% ductility notched Izod impact strength when tested in accordance with ASTM D256 at 0° C. In yet a further aspect, the molded sample comprising the blended thermoplastic composition has at least 40% ductility notched Izod impact strength when tested in accordance with ASTM D256 at 0° C. In an even further aspect, the molded sample comprising the blended thermoplastic composition has at least 60% ductility notched Izod impact strength when tested in accordance with ASTM D256 at 0° C. In a still further aspect, the molded sample comprising the blended thermoplastic composition has at least 80% ductility notched Izod impact strength when tested in accordance with ASTM D256 at 0° C. In yet a further aspect, the molded sample comprising the blended thermoplastic composition has 100% ductility notched Izod impact strength when tested in accordance with ASTM D256 at 0° C.

In other aspects, the molded sample comprising the blended thermoplastic composition has greater than 0% ductility notched Izod impact strength when tested in accordance with ASTM D256 at −20° C. In a still further aspect, the molded sample comprising the blended thermoplastic composition has at least 20% ductility notched Izod impact strength when tested in accordance with ASTM D256 at −20° C. In yet a further aspect, the molded sample comprising the blended thermoplastic composition has at least 40% ductility notched Izod impact strength when tested in accordance with ASTM D256 −20° C. In an even further aspect, the molded sample comprising the blended thermoplastic composition has at least 60% ductility notched Izod impact strength when tested in accordance with ASTM D256 at −20° C. In a still further aspect, the molded sample comprising the blended thermoplastic composition has at least 80% ductility notched Izod impact strength when tested in accordance with ASTM D256 at −20° C. In yet a further aspect, the molded sample comprising the blended thermoplastic composition has 100% ductility notched Izod impact strength when tested in accordance with ASTM D256 at −20° C.

In a further aspect, the molded sample comprising the blended thermoplastic composition is capable of achieving UL94 V0 rating at a thickness of at least about 1.5 mm (±10%). In a still further aspect, the molded sample comprising the blended thermoplastic composition is capable of achieving UL94 V0 rating at a thickness of at least about 1.4 mm (±10%). In yet a further aspect, the molded sample comprising the blended thermoplastic composition is capable of achieving UL94 V0 rating at a thickness of at least about 1.3 mm (±10%). In an even further aspect, the molded sample comprising the blended thermoplastic composition is capable of achieving UL94 V0 rating at a thickness of at least about 1.2 mm (±10%). In a still further aspect, the molded sample comprising the blended thermoplastic composition is capable of achieving UL94 V0 rating at a thickness of at least about 0.8 mm (±10%). In yet a further aspect, the molded sample comprising the blended thermoplastic composition is capable of achieving UL94 V0 rating at a thickness of at least about 0.7 mm (±10%). In an even further aspect, the molded sample comprising the blended thermoplastic composition is capable of achieving UL94 V0 rating at a thickness of at least about 0.6 mm (±10%). In a still further aspect, the molded sample comprising the blended thermoplastic composition is capable of achieving UL94 V0 rating at a thickness of at least about 0.5 mm (±10%).

In various further aspects, the disclosed blended thermoplastic compositions can optionally further comprise at least one additive. In a further aspect, the disclosed blended thermoplastic compositions can optionally further comprise at least one additive selected from an anti-drip agent, antioxidant, antistatic agent, chain extender, colorant, de-molding agent, dye, flow promoter, filler, flow modifier, light stabilizer, lubricant, mold release agent, pigment, quenching agent, thermal stabilizer, UV absorbent substance, UV reflectant substance, and UV stabilizer, or combinations thereof.

In further aspects, the invention also relates to methods for making the disclosed thermoplastic compositions.

In still further aspects, the invention relates to articles and products comprising the disclosed thermoplastic compositions.

### Polycarbonate Component

In one aspect, the disclosed blended thermoplastic compositions comprise a polycarbonate polymer composition wherein the polycarbonate polymer comprising bisphenol A, a polycarbonate copolymer, or polycarbonate-polysiloxane copolymer, or combinations thereof.

In one aspect, a polycarbonate can comprise any polycarbonate material or mixture of materials, for example, as recited in U.S. Pat. No. 7,786,246, which is hereby incorporated in its entirety for the specific purpose of disclosing various polycarbonate compositions and methods. The term polycarbonate can be further defined as compositions have repeating structural units of the formula (1):

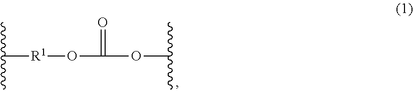

in which at least 60 percent of the total number of R¹ groups are aromatic organic radicals and the balance thereof are aliphatic, alicyclic, or aromatic radicals. In a further aspect, each R¹ is an aromatic organic radical and, more preferably, a radical of the formula (2):

-A¹-Y¹-A²- (2),

wherein each of A¹ and A² is a monocyclic divalent aryl radical and Y¹ is a bridging radical having one or two atoms that separate A¹ from A². In various aspects, one atom separates A¹ from A². For example, radicals of this type include, but are not limited to, radicals such as —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ is preferably a hydrocarbon group or a saturated hydrocarbon group such as methylene, cyclohexylidene, or isopropylidene.

In a further aspect, polycarbonates can be produced by the interfacial reaction of dihydroxy compounds having the formula HO—R¹—OH, which includes dihydroxy compounds of formula (3):

HO-A¹-Y¹-A²-OH (3),

wherein Y¹, A¹ and A² are as described above. Also included are bisphenol compounds of general formula (4):

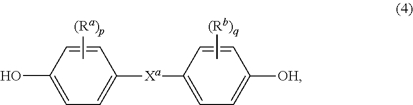

wherein R^{a} and R^{b} each represent a halogen atom or a monovalent hydrocarbon group and can be the same or different; p and q are each independently integers from 0 to 4; and X^{a} represents one of the groups of formula (5):

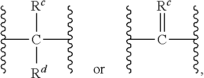

wherein R^{c} and R^{d} each independently represent a hydrogen atom or a monovalent linear or cyclic hydrocarbon group and R^{e} is a divalent hydrocarbon group.

In various aspects, a heteroatom-containing cyclic alkylidene group comprises at least one heteroatom with a valency of 2 or greater, and at least two carbon atoms. Heteroatoms for use in the heteroatom-containing cyclic alkylidene group include —O—, —S—, and —N(Z)—, where Z is a substituent group selected from hydrogen, hydroxy, C₁₋₁₂ alkyl, C₁₋₁₂ alkoxy, or C₁₋₁₂ acyl. Where present, the cyclic alkylidene group or heteroatom-containing cyclic alkylidene group can have 3 to 20 atoms, and can be a single saturated or unsaturated ring, or fused polycyclic ring system wherein the fused rings are saturated, unsaturated, or aromatic.

In various aspects, examples of suitable dihydroxy compounds include the dihydroxy-substituted hydrocarbons disclosed by name or formula (generic or specific) in U.S. Pat. No. 4,217,438. A nonexclusive list of specific examples of suitable dihydroxy compounds includes the following: resorcinol, 4-bromoresorcinol, hydroquinone, 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, 2,7-dihydroxycarbazole, 3,3-bis(4-hydroxyphenyl)phthalimidine, 2-phenyl-3,3-bis-(4-hydroxyphenyl)phthalimidine (PPPBP), and the like, as well as mixtures including at least one of the foregoing dihydroxy compounds.

In a further aspect, examples of the types of bisphenol compounds that can be represented by formula (3) includes 1,1-bis(4-hydroxyphenyl)methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl) n-butane, 2,2-bis(4-hydroxy-1-methylphenyl)propane, and 1,1-bis(4-hydroxy-t-butylphenyl)propane. Combinations including at least one of the foregoing dihydroxy compounds can also be used. In various further aspects, bisphenols containing substituted or unsubstituted cyclohexane units can be used, for example bisphenols of formula (6):

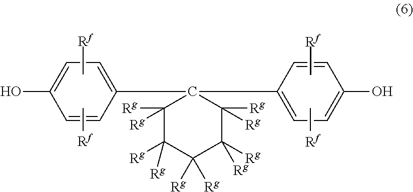

wherein each R^{f} is independently hydrogen, C₁₋₁₂ alkyl, or halogen; and each R^{g} is independently hydrogen or C₁₋₁₂ alkyl. The substituents can be aliphatic or aromatic, straight chain, cyclic, bicyclic, branched, saturated, or unsaturated. Such cyclohexane-containing bisphenols, for example the reaction product of two moles of a phenol with one mole of a hydrogenated isophorone, are useful for making polycarbonate polymers with high glass transition temperatures and high heat distortion temperatures, Cyclohexyl bisphenol containing polycarbonates, or a combination comprising at least one of the foregoing with other bisphenol polycarbonates, are supplied by Bayer Co. under the APEC® trade name.

In further aspects, additional useful dihydroxy compounds are those compounds having the formula —HO—R¹—OH include aromatic dihydroxy compounds of formula (7):

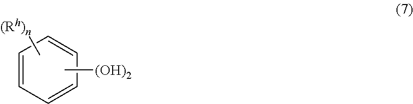

wherein each R^{h} is independently a halogen atom, a C₁₋₁₀ hydrocarbyl such as a C₁₋₁₀ alkyl group, a halogen substituted C₁₋₁₀ hydrocarbyl such as a halogen-substituted C₁₋₁₀ alkyl group, and n is 0 to 4. The halogen is usually bromine.

In addition to the polycarbonates described above, combinations of the polycarbonate with other thermoplastic polymers, for example combinations of homopolycarbonates and/or polycarbonate copolymers, can be used.

In various aspects, a polycarbonate can employ two or more different dihydroxy compounds or a copolymer of a dihydroxy compounds with a glycol or with a hydroxy- or acid-terminated polyester or with a dibasic acid or hydroxy acid in the event a carbonate copolymer rather than a homopolymer is desired for use. Polyarylates and polyester-carbonate resins or their blends can also be employed. Branched polycarbonates are also useful, as well as blends of linear polycarbonate and a branched polycarbonate. The branched polycarbonates can be prepared by adding a branching agent during polymerization.

In a further aspect, the branching agents include polyfunctional organic compounds containing at least three functional groups selected from hydroxyl, carboxyl, carboxylic anhydride, haloformyl, and mixtures thereof. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha, alpha-dimethyl benzyl)phenol), 4-chloroformyl phthalic anhydride, trimesic acid, and benzophenone tetracarboxylic acid. The branching agents can be added at a level of from 0.05-2.0 weight percent. Branching agents and procedures for making branched polycarbonates are described in U.S. Pat. Nos. 3,635,895 and 4,001,184. All types of polycarbonate end groups are contemplated as being useful in the thermoplastic composition.

In a further aspect, the polycarbonate can be a linear homopolymer derived from bisphenol A, in which each of A¹ and A² is p-phenylene and Y¹ is isopropylidene. The polycarbonates generally can have an intrinsic viscosity, as determined in chloroform at 25° C., of 0.3 to 1.5 deciliters per gram (dl/g), specifically 0.45 to 1.0 dl/g. The polycarbonates can have a weight average molecular weight (Mw) of 10,000 to 100,000 g/mol, as measured by gel permeation chromatography (GPC) using a crosslinked styrene-divinyl benzene column, at a sample concentration of 1 milligram per milliliter, and as calibrated with polycarbonate standards. In a yet further aspect, the polycarbonate has an Mw of about 15,000 to about 55,000. In an even further aspect, the polycarbonate has an Mw of about 18,000 to about 40,000.

In a further aspect, a polycarbonate component used in the formulations of the present invention can have a melt volume flow rate (often abbreviated MVR) measures the rate of extrusion of a thermoplastics through an orifice at a prescribed temperature and load. Polycarbonates useful for the formation of articles can have an MVR, measured at 300° C. under a load of 1.2 kg according to ASTM D1238-04 or ISO 1133, of 0.5 to 80 cubic centimeters per 10 minutes (cc/10 min). In a still further aspect, the polycarbonate component comprises a two polycarbonate polymers wherein one of the polycarbonate polymers is a poly(aliphatic ester)-polycarbonate. In cases where the polycarbonate components comprises a non-poly(aliphatic ester)-polycarbonate and a poly(aliphatic ester)-polycarbonate, the non-poly(aliphatic ester)-polycarbonate (or a combination of such polycarbonates) can have a MVR measured at 300° C. under a load of 1.2 kg according to ASTM D1238-04 or ISO 1133, of 45 to 75 cc/10 min, specifically 50 to 70 cc/10 min, and more specifically 55 to 65 cc/10 min.

Polycarbonates, including isosorbide-based polyester-polycarbonate, can comprise copolymers comprising carbonate units and other types of polymer units, including ester units, and combinations comprising at least one of homopolycarbonates and copolycarbonates. An exemplary polycarbonate copolymer of this type is a polyester carbonate, also known as a polyester-polycarbonate or polyester carbonate. Such copolymers further contain carbonate units derived from oligomeric ester-containing dihydroxy compounds (also referred to herein as hydroxy end-capped oligomeric acrylate esters).

In various further aspects, “polycarbonates” and “polycarbonate resins” as used herein further include homopolycarbonates, copolymers comprising different R¹ moieties in the carbonate (referred to herein as “copolycarbonates”), copolymers comprising carbonate units and other types of polymer units, such as ester units, polysiloxane units, and combinations comprising at least one of homopolycarbonates and copolycarbonates. As used herein, “combination” is inclusive of blends, mixtures, alloys, reaction products, and the like. A specific type of copolymer is a polyester carbonate, also known as a polyester-polycarbonate. Such copolymers further contain, in addition to recurring carbonate chain units of the formula (1), units of formula (8):

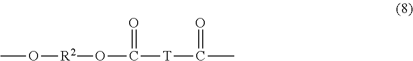

wherein R² is a divalent group derived from a dihydroxy compound, and can be, for example, a C₂₋₁₀ alkylene group, a C₆₋₂₀ alicyclic group, a C₆₋₂₀ aromatic group or a polyoxyalkylene group in which the alkylene groups contain 2 to about 6 carbon atoms, specifically 2, 3, or 4 carbon atoms; and T is a divalent group derived from a dicarboxylic acid (aliphatic, aromatic, or alkyl aromatic), and can be, for example, a C₄₋₁₈ aliphatic group, a C₆₋₂₀ alkylene group, a C₆₋₂₀ alkylene group, a C₆₋₂₀ alicyclic group, a C₆₋₂₀ alkyl aromatic group, or a C₆₋₂₀ aromatic group. R² can be is a C₂₋₃₀ alkylene group having a straight chain, branched chain, or cyclic (including polycyclic) structure. Alternatively, R² can be derived from an aromatic dihydroxy compound of formula (4) above, or from an aromatic dihydroxy compound of formula (7) above.

Examples of aromatic dicarboxylic acids that can be used to prepare the polyester units include isophthalic or terephthalic acid, 1,2-di(p-carboxyphenyl)ethane, 4,4′-dicarboxydiphenyl ether, 4,4′-bisbenzoic acid, and combinations comprising at least one of the foregoing acids. Acids containing fused rings can also be present, such as in 1,4-, 1,5-, or 2,6-naphthalenedicarboxylic acids. Examples of specific dicarboxylic acids are terephthalic acid, isophthalic acid, naphthalene dicarboxylic acid, cyclohexane dicarboxylic acid, or combinations thereof. In various aspects, an example of a specific dicarboxylic acid comprises a combination of isophthalic acid and terephthalic acid wherein the weight ratio of isophthalic acid to terephthalic acid is about 91:9 to about 2:98. In another aspect, R² is a C₂₋₆ alkylene group and T is p-phenylene, m-phenylene, naphthalene, a divalent cycloaliphatic group, or a combination thereof. This class of polyester includes the poly(alkylene terephthalates).

The molar ratio of ester units to carbonate units in the copolymers can vary broadly, for example 1:99 to 99:1, specifically 10:90 to 90:10, more specifically 25:75 to 75:25, depending on the desired properties of the final composition.

In a further aspect, the thermoplastic composition comprises a polyester-polycarbonate copolymer, and specifically a polyester-polycarbonate copolymer in which the ester units of formula (8) comprise soft block ester units, also referred to herein as aliphatic dicarboxylic acid ester units. Such a polyester-polycarbonate copolymer comprising soft block ester units is also referred to herein as a poly(aliphatic ester)-polycarbonate. The soft block ester unit can be a C₆₋₂₀ aliphatic dicarboxylic acid ester unit (where C₆₋₂₀ includes the terminal carboxyl groups), and can be straight chain (i.e., unbranched) or branched chain dicarboxylic acids, cycloalkyl or cycloalkylidene-containing dicarboxylic acids units, or combinations of these structural units. In a still further aspect, the C₆₋₂₀ aliphatic dicarboxylic acid ester unit includes a straight chain alkylene group comprising methylene (—CH₂—) repeating units. In a yet further aspect, a useful soft block ester unit comprises units of formula (8a):

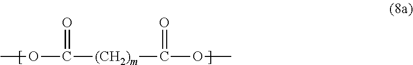

where m is 4 to 18. In a further aspect of formula (8a), m is 8 to 10. The poly(aliphatic ester)-polycarbonate can include less than or equal to 25 wt % of the soft block unit. In a still further aspect, a poly(aliphatic ester)-polycarbonate comprises units of formula (8a) in an amount of 0.5 to 10 wt %, specifically 1 to 9 wt %, and more specifically 3 to 8 wt %, based on the total weight of the poly(aliphatic ester)-polycarbonate.

The poly(aliphatic ester)-polycarbonate is a copolymer of soft block ester units and carbonate units. The poly(aliphatic ester)-polycarbonate is shown in formula (8b):

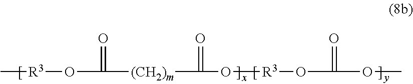

where each R³ is independently derived from a dihydroxyaromatic compound of formula (4) or (7), m is 4 to 18, and x and y each represent average weight percentages of the poly(aliphatic ester)-polycarbonate where the average weight percentage ratio x:y is 10:90 to 0.5:99.5, specifically 9:91 to 1:99, and more specifically 8:92 to 3:97, where x+y is 100.

Soft block ester units, as defined herein, can be derived from an alpha, omega C₆₋₂₀ aliphatic dicarboxylic acid or a reactive derivative thereof. In a further aspect, the soft block ester units can be derived from an alpha, omega C₁₀₋₁₂ aliphatic dicarboxylic acid or a reactive derivative thereof. In a still further aspect, the carboxylate portion of the aliphatic ester unit of formula (8a), in which the terminal carboxylate groups are connected by a chain of repeating methylene (—CH₂—) units (where m is as defined for formula (8a)), is derived from the corresponding dicarboxylic acid or reactive derivative thereof, such as the acid halide (specifically, the acid chloride), an ester, or the like. Exemplary alpha, omega dicarboxylic acids (from which the corresponding acid chlorides can be derived) include alpha, omega C₆ dicarboxylic acids such as hexanedioic acid (also referred to as adipic acid); alpha, omega C₁₀ dicarboxylic acids such as decanedioic acid (also referred to as sebacic acid); and alpha, omega C₁₂ dicarboxylic acids such as dodecanedioic acid (sometimes abbreviated as DDDA). It will be appreciated that the aliphatic dicarboxylic acid is not limited to these exemplary carbon chain lengths, and that other chain lengths within the C₆₋₂₀ limitation can be used. In various further aspects, the poly(aliphatic ester)-polycarbonate having soft block ester units comprising a straight chain methylene group and a bisphenol A polycarbonate group is shown in formula (8c):

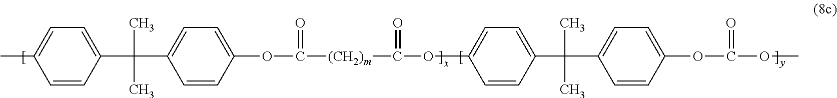

where m is 4 to 18 and x and y are as defined for formula (8b). In a specific exemplary aspect, a useful poly(aliphatic ester)-polycarbonate copolymer comprises sebacic acid ester units and bisphenol A carbonate units (formula (8c), where m is 8, and the average weight ratio of x:y is 6:94).

Desirably, the poly(aliphatic ester)-polycarbonate has a glass transition temperature (Tg) of 110 to 145° C., specifically 115 to 145° C., more specifically 120 to 145° C., more specifically 128 to 139° C., and still more specifically 130 to 139° C.

In one aspect, polycarbonates, including polyester-polycarbonates, can be manufactured by processes such as interfacial polymerization and melt polymerization.

The polycarbonate compounds and polymers disclosed herein can, in various aspects, be prepared by a melt polymerization process. Generally, in the melt polymerization process, polycarbonates are prepared by co-reacting, in a molten state, the dihydroxy reactant(s) (i.e., isosorbide, aliphatic diol and/or aliphatic diacid, and any additional dihydroxy compound) and a diaryl carbonate ester, such as diphenyl carbonate, or more specifically in an aspect, an activated carbonate such as bis(methyl salicyl)carbonate, in the presence of a transesterification catalyst. The reaction can be carried out in typical polymerization equipment, such as one or more continuously stirred reactors (CSTRs), plug flow reactors, wire wetting fall polymerizers, free fall polymerizers, wiped film polymerizers, BANBURY® mixers, single or twin screw extruders, or combinations of the foregoing. In one aspect, volatile monohydric phenol can be removed from the molten reactants by distillation and the polymer is isolated as a molten residue.

The melt polymerization can include a transesterification catalyst comprising a first catalyst, also referred to herein as an alpha catalyst, comprising a metal cation and an anion. In an aspect, the cation is an alkali or alkaline earth metal comprising Li, Na, K, Cs, Rb, Mg, Ca, Ba, Sr, or a combination comprising at least one of the foregoing. The anion is hydroxide (OH⁻), superoxide (O²⁻), thiolate (HS⁻), sulfide (S²⁻), a C₁₋₂₀ alkoxide, a C₆₋₂₀ aryloxide, a C₁₋₂₀ carboxylate, a phosphate including biphosphate, a C₁₋₂₀ phosphonate, a sulfate including bisulfate, sulfites including bisulfites and metabisulfites, a C₁₋₂₀ sulfonate, a carbonate including bicarbonate, or a combination comprising at least one of the foregoing. In another aspect, salts of an organic acid comprising both alkaline earth metal ions and alkali metal ions can also be used. Salts of organic acids useful as catalysts are illustrated by alkali metal and alkaline earth metal salts of formic acid, acetic acid, stearic acid and ethyelenediaminetetraacetic acid. The catalyst can also comprise the salt of a non-volatile inorganic acid. By “nonvolatile”, it is meant that the referenced compounds have no appreciable vapor pressure at ambient temperature and pressure. In particular, these compounds are not volatile at temperatures at which melt polymerizations of polycarbonate are typically conducted. The salts of nonvolatile acids are alkali metal salts of phosphites; alkaline earth metal salts of phosphites; alkali metal salts of phosphates; and alkaline earth metal salts of phosphates. Exemplary transesterification catalysts include, lithium hydroxide, sodium hydroxide, potassium hydroxide, cesium hydroxide, magnesium hydroxide, calcium hydroxide, barium hydroxide, lithium formate, sodium formate, potassium formate, cesium formate, lithium acetate, sodium acetate, potassium acetate, lithium carbonate, sodium carbonate, potassium carbonate, lithium methoxide, sodium methoxide, potassium methoxide, lithium ethoxide, sodium ethoxide, potassium ethoxide, lithium phenoxide, sodium phenoxide, potassium phenoxide, sodium sulfate, potassium sulfate, NaH₂PO₃, NaH₂PO₄, Na₂H₂PO₃, KH₂PO₄, CsH₂PO₄, Cs₂H₂PO₄, Na₂SO₃, Na₂S₂O₅, sodium mesylate, potassium mesylate, sodium tosylate, potassium tosylate, magnesium disodium ethylenediamine tetraacetate (EDTA magnesium disodium salt), or a combination comprising at least one of the foregoing. It will be understood that the foregoing list is exemplary and should not be considered as limited thereto. In one aspect, the transesterification catalyst is an alpha catalyst comprising an alkali or alkaline earth salt. In an exemplary aspect, the transesterification catalyst comprising sodium hydroxide, potassium hydroxide, sodium carbonate, potassium carbonate, sodium methoxide, potassium methoxide, NaH₂PO₄, or a combination comprising at least one of the foregoing.

The amount of alpha catalyst can vary widely according to the conditions of the melt polymerization, and can be about 0.001 to about 500 μmol. In an aspect, the amount of alpha catalyst can be about 0.01 to about 20 μmol, specifically about 0.1 to about 10 μmol, more specifically about 0.5 to about 9 μmol, and still more specifically about 1 to about 7 μmol, per mole of aliphatic diol and any other dihydroxy compound present in the melt polymerization.

In another aspect, a second transesterification catalyst, also referred to herein as a beta catalyst, can optionally be included in the melt polymerization process, provided that the inclusion of such a second transesterification catalyst does not significantly adversely affect the desirable properties of the polycarbonate. Exemplary transesterification catalysts can further include a combination of a phase transfer catalyst of formula (R³)₄Q⁺X above, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Exemplary phase transfer catalyst salts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. Examples of such transesterification catalysts include tetrabutylammonium hydroxide, methyltributylammonium hydroxide, tetrabutylammonium acetate, tetrabutylphosphonium hydroxide, tetrabutylphosphonium acetate, tetrabutylphosphonium phenolate, or a combination comprising at least one of the foregoing. Other melt transesterification catalysts include alkaline earth metal salts or alkali metal salts. In various aspects, where a beta catalyst is desired, the beta catalyst can be present in a molar ratio, relative to the alpha catalyst, of less than or equal to 10, specifically less than or equal to 5, more specifically less than or equal to 1, and still more specifically less than or equal to 0.5. In other aspects, the melt polymerization reaction disclosed herein uses only an alpha catalyst as described hereinabove, and is substantially free of any beta catalyst. As defined herein, “substantially free of” can mean where the beta catalyst has been excluded from the melt polymerization reaction. In one aspect, the beta catalyst is present in an amount of less than about 10 ppm, specifically less than 1 ppm, more specifically less than about 0.1 ppm, more specifically less than or equal to about 0.01 ppm, and more specifically less than or equal to about 0.001 ppm, based on the total weight of all components used in the melt polymerization reaction.

In one aspect, an end-capping agent (also referred to as a chain-stopper) can optionally be used to limit molecular weight growth rate, and so control molecular weight in the polycarbonate. Exemplary chain-stoppers include certain monophenolic compounds (i.e., phenyl compounds having a single free hydroxy group), monocarboxylic acid chlorides, and/or monochloroformates. Phenolic chain-stoppers are exemplified by phenol and C₁-C₂₂ alkyl-substituted phenols such as p-cumyl-phenol, resorcinol monobenzoate, and p- and tertiary-butyl phenol, cresol, and monoethers of diphenols, such as p-methoxyphenol. Alkyl-substituted phenols with branched chain alkyl substituents having 8 to 9 carbon atoms can be specifically mentioned.

In another aspect, endgroups can be derived from the carbonyl source (i.e., the diaryl carbonate), from selection of monomer ratios, incomplete polymerization, chain scission, and the like, as well as any added end-capping groups, and can include derivatizable functional groups such as hydroxy groups, carboxylic acid groups, or the like. In one aspect, the endgroup of a polycarbonate, including a polycarbonate polymer as defined herein, can comprise a structural unit derived from a diaryl carbonate, where the structural unit can be an endgroup. In a further aspect, the endgroup is derived from an activated carbonate. Such endgroups can be derived from the transesterification reaction of the alkyl ester of an appropriately substituted activated carbonate, with a hydroxy group at the end of a polycarbonate polymer chain, under conditions in which the hydroxy group reacts with the ester carbonyl from the activated carbonate, instead of with the carbonate carbonyl of the activated carbonate. In this way, structural units derived from ester containing compounds or substructures derived from the activated carbonate and present in the melt polymerization reaction can form ester endgroups.

In one aspect, the melt polymerization reaction can be conducted by subjecting the reaction mixture to a series of temperature-pressure-time protocols. In some aspects, this involves gradually raising the reaction temperature in stages while gradually lowering the pressure in stages. In one aspect, the pressure is reduced from about atmospheric pressure at the start of the reaction to about 1 millibar (100 Pa) or lower, or in another aspect to 0.1 millibar (10 Pa) or lower in several steps as the reaction approaches completion. The temperature can be varied in a stepwise fashion beginning at a temperature of about the melting temperature of the reaction mixture and subsequently increased to final temperature. In one aspect, the reaction mixture is heated from room temperature to about 150° C. In such an aspect, the polymerization reaction starts at a temperature of about 150° C. to about 220° C. In another aspect, the polymerization temperature can be up to about 220° C. In other aspects, the polymerization reaction can then be increased to about 250° C. and then optionally further increased to a temperature of about 320° C., and all subranges there between. In one aspect, the total reaction time can be from about 30 minutes to about 200 minutes and all subranges there between. This procedure will generally ensure that the reactants react to give polycarbonates with the desired molecular weight, glass transition temperature and physical properties. The reaction proceeds to build the polycarbonate chain with production of ester-substituted alcohol by-product such as methyl salicylate. In one aspect, efficient removal of the by-product can be achieved by different techniques such as reducing the pressure. Generally the pressure starts relatively high in the beginning of the reaction and is lowered progressively throughout the reaction and temperature is raised throughout the reaction.

In one aspect, the progress of the reaction can be monitored by measuring the melt viscosity or the weight average molecular weight of the reaction mixture using techniques known in the art such as gel permeation chromatography. These properties can be measured by taking discrete samples or can be measured on-line. After the desired melt viscosity and/or molecular weight is reached, the final polycarbonate product can be isolated from the reactor in a solid or molten form. It will be appreciated by a person skilled in the art, that the method of making aliphatic homopolycarbonate and aliphatic-aromatic copolycarbonates as described in the preceding sections can be made in a batch or a continuous process and the process disclosed herein is preferably carried out in a solvent free mode. Reactors chosen should ideally be self-cleaning and should minimize any “hot spots.” However, vented extruders similar to those that are commercially available can be used.

Polycarbonates, including polyester-polycarbonates, can be also be manufactured by interfacial polymerization. Although the reaction conditions for interfacial polymerization can vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like.

Carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used. In an exemplary aspect, an interfacial polymerization reaction to form carbonate linkages uses phosgene as a carbonate precursor, and is referred to as a phosgenation reaction.

Among the phase transfer catalysts that can be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Useful phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst can be about 0.1 to about 10 wt % based on the weight of bisphenol in the phosgenation mixture. In another aspect, an effective amount of phase transfer catalyst can be about 0.5 to about 2 wt % based on the weight of bisphenol in the phosgenation mixture.

All types of polycarbonate end groups are contemplated as being useful in the polycarbonate composition, provided that such end groups do not significantly adversely affect desired properties of the compositions.

Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha, alpha-dimethyl benzyl)phenol), 4-chloroformyl phthalic anhydride, trimesic acid, and benzophenone tetracarboxylic acid. The branching agents can be added at a level of about 0.05 to about 2.0 wt %. Mixtures comprising linear polycarbonates and branched polycarbonates can be used.

A chain stopper (also referred to as a capping agent) can be included during polymerization. The chain stopper limits molecular weight growth rate, and so controls molecular weight in the polycarbonate. Exemplary chain stoppers include certain mono-phenolic compounds, monocarboxylic acid chlorides, and/or monochloroformates. Mono-phenolic chain stoppers are exemplified by monocyclic phenols such as phenol and C₁-C₂₂ alkyl-substituted phenols such as p-cumyl-phenol, resorcinol monobenzoate, and p- and tertiary-butyl phenol; and monoethers of diphenols, such as p-methoxyphenol. Alkyl-substituted phenols with branched chain alkyl substituents having 8 to 9 carbon atom can be specifically mentioned. Certain mono-phenolic UV absorbers can also be used as a capping agent, for example 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like.

Mono-carboxylic acid chlorides can also be used as chain stoppers. These include monocyclic, mono-carboxylic acid chlorides such as benzoyl chloride, C₁-C₂₂ alkyl-substituted benzoyl chloride, toluoyl chloride, halogen-substituted benzoyl chloride, bromobenzoyl chloride, cinnamoyl chloride, 4-nadimidobenzoyl chloride, and combinations thereof; polycyclic, mono-carboxylic acid chlorides such as trimellitic anhydride chloride, and naphthoyl chloride; and combinations of monocyclic and polycyclic mono-carboxylic acid chlorides. Chlorides of aliphatic monocarboxylic acids with less than or equal to about 22 carbon atoms are useful. Functionalized chlorides of aliphatic monocarboxylic acids, such as acryloyl chloride and methacryoyl chloride, are also useful. Also useful are mono-chloroformates including monocyclic, mono-chloroformates, such as phenyl chloroformate, alkyl-substituted phenyl chloroformate, p-cumyl phenyl chloroformate, toluene chloroformate, and combinations thereof.

Specifically, polyester-polycarbonates, including poly(aliphatic ester)-polycarbonates, can be prepared by interfacial polymerization. Rather than utilizing the dicarboxylic acid (such as the alpha, omega C₆₋₂₀ aliphatic dicarboxylic acid) per se, it is possible, and sometimes even preferred, to employ the reactive derivatives of the dicarboxylic acid, such as the corresponding dicarboxylic acid halides, and in particular the acid dichlorides and the acid dibromides. Thus, for example instead of using isophthalic acid, terephthalic acid, or a combination comprising at least one of the foregoing (for poly(arylate ester)-polycarbonates), it is possible to employ isophthaloyl dichloride, terephthaloyl dichloride, and a combination comprising at least one of the foregoing. Similarly, for the poly(aliphatic ester)-polycarbonates, it is possible, and even desirable, to use for example acid chloride derivatives such as a C₆ dicarboxylic acid chloride (adipoyl chloride), a C₁₀ dicarboxylic acid chloride (sebacoyl chloride), or a C₁₂ dicarboxylic acid chloride (dodecanedioyl chloride). The dicarboxylic acid or reactive derivative can be condensed with the dihydroxyaromatic compound in a first condensation, followed by in situ phosgenation to generate the carbonate linkages with the dihydroxyaromatic compound. Alternatively, the dicarboxylic acid or derivative can be condensed with the dihydroxyaromatic compound simultaneously with phosgenation.

In an aspect, where the melt volume rate of an otherwise compositionally suitable poly(aliphatic ester)-polycarbonate is not suitably high, i.e., where the MVR is less than 13 cc/10 min when measured at 250° C., under a load of 1.2 kg, the poly(aliphatic ester)-polycarbonate can be modified to provide a reaction product with a higher flow (i.e., greater than or equal to 13 cc/10 min when measured at 250° C., under a load of 1.2 kg), by treatment using a redistribution catalyst under conditions of reactive extrusion. During reactive extrusion, the redistribution catalyst is typically included in small amounts of less than or equal to 400 ppm by weight, by injecting a dilute aqueous solution of the redistribution catalyst into the extruder being fed with the poly(aliphatic ester)-polycarbonate.

In a further aspect, the redistribution-catalyst is a tetraalkylphosphonium hydroxide, tetraalkylphosphonium alkoxide, tetraalkylphosphonium aryloxide, a tetraalkylphosphonium carbonate, a tetraalkylammonium hydroxide, a tetraalkylammonium carbonate, a tetraalkylammonium phosphite, a tetraalkylammonium acetate, or a combination comprising at least one of the foregoing catalysts, wherein each alkyl is independently a C₁₋₆ alkyl. In a specific aspect, a useful redistribution catalyst is a tetra C₁₋₆ alkylphosphonium hydroxide, C₁₋₆ alkyl phosphonium phenoxide, or a combination comprising one or more of the foregoing catalysts. An exemplary redistribution catalyst is tetra-n-butylphosphonium hydroxide.

In a further aspect, the redistribution catalyst is present in an amount of 40 to 120 ppm, specifically 40 to 110 ppm, and more specifically 40 to 100 ppm, by weight based on the weight of the poly(aliphatic ester)-polycarbonate.

Copolymers comprising alkylene terephthalate repeating ester units with other ester groups can also be useful. Useful ester units can include different alkylene terephthalate units, which can be present in the polymer chain as individual units, or as blocks of poly(alkylene terephthalates). Specific examples of such copolymers include poly(cyclohexanedimethylene terephthalate)-co-poly(ethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate).

Poly(cycloalkylene diester)s can also include poly(alkylene cyclohexanedicarboxylate)s. Of these, a specific example is poly(1,4-cyclohexane-dimethanol-1,4-cyclohexanedicarboxylate) (PCCD), having recurring units of formula (9):

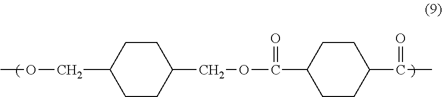

wherein, as described using formula (8), R² is a 1,4-cyclohexanedimethylene group derived from 1,4-cyclohexanedimethanol, and T is a cyclohexane ring derived from cyclohexanedicarboxylate or a chemical equivalent thereof, and can comprise the cis-isomer, the trans-isomer, or a combination comprising at least one of the foregoing isomers.

The polyesters can be obtained by interfacial polymerization or melt-process condensation as described above, by solution phase condensation, or by transesterification polymerization wherein, for example, a dialkyl ester such as dimethyl terephthalate can be transesterified with ethylene glycol using acid catalysis, to generate poly(ethylene terephthalate). It is possible to use a branched polyester in which a branching agent, for example, a glycol having three or more hydroxyl groups or a trifunctional or multifunctional carboxylic acid has been incorporated. Furthermore, it is sometime desirable to have various concentrations of acid and hydroxyl end groups on the polyester, depending on the ultimate end use of the composition.

Polyester-polycarbonate copolymers generally can have a weight average molecular weight (Mw) of 1,500 to 100,000 g/mol, specifically 1,700 to 50,000 g/mol. In an aspect, poly(aliphatic ester)-polycarbonates have a molecular weight of 15,000 to 45,000 g/mol, specifically 17,000 to 40,000 g/mol, more specifically 20,000 to 30,000 g/mol, and still more specifically 20,000 to 25,000 g/mol. Molecular weight determinations are performed using gel permeation chromatography (GPC), using a crosslinked styrene-divinylbenzene column and calibrated to polycarbonate references. Samples are prepared at a concentration of about 1 mg/ml, and are eluted at a flow rate of about 1.0 ml/min.

As used herein, the term polycarbonate-polysiloxane copolymer is equivalent to polysiloxane-polycarbonate copolymer, polycarbonate-polysiloxane polymer, or polysiloxane-polycarbonate polymer. In various aspects, the polycarbonate-polysiloxane copolymer can be a block copolymer comprising one or more polycarbonate blocks and one or more polysiloxane blocks. The polysiloxane-polycarbonate copolymer comprises polydiorganosiloxane blocks comprising structural units of the general formula (I) below:

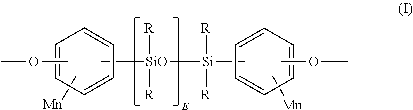

wherein the polydiorganosiloxane block length (E) is from about 20 to about 60; wherein each R group can be the same or different, and is selected from a C₁₋₁₃ monovalent organic group; wherein each M can be the same or different, and is selected from a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkylaryl, or C₇-C₁₂ alkylaryloxy, and where each n is independently 0, 1, 2, 3, or 4. The polysiloxane-polycarbonate copolymer also comprises polycarbonate blocks comprising structural units of the general formula (II) below:

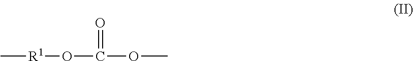

wherein at least 60 percent of the total number of R¹ groups comprise aromatic moieties and the balance thereof comprise aliphatic, alicyclic, or aromatic moieties.

According to exemplary non-limiting aspects of the disclosure, the polycarbonate-polysiloxane block copolymer comprises diorganopolysiloxane blocks of the general formula (III) below:

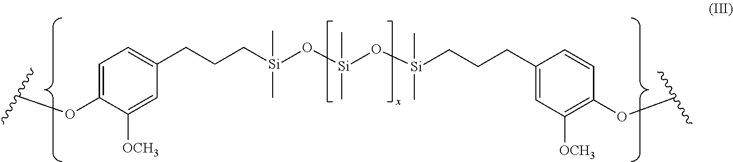

wherein x represents an integer from about 20 to about 60. The polycarbonate blocks according to these aspects can be derived from bisphenol-A monomers.

Diorganopolysiloxane blocks of formula (III) above can be derived from the corresponding dihydroxy compound of formula (IV):

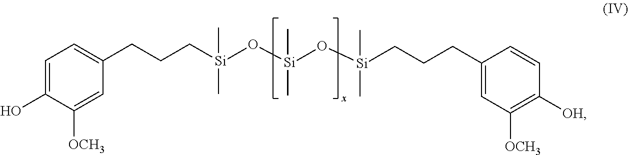

wherein x is as described above. Compounds of this type and others are further described in U.S. Pat. No. 4,746,701 to Kress, et al and U.S. Pat. No. 8,017,0697 to Carrillo. Compounds of this formula can be obtained by the reaction of the appropriate dihydroxyarylene compound with, for example, an alpha, omega-bisacetoxypolydiorangonosiloxane under phase transfer conditions.

Such dihydroxy polysiloxanes can be made by effecting a platinum catalyzed addition between a siloxane hydride of the formula (V):

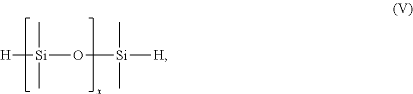

wherein x is a previously defined, and an aliphatically unsaturated monohydric phenol such as eugenol to yield a compound of formula (IV).

The polycarbonate-polysiloxane copolymer can be manufactured by reaction of a diphenolic polysiloxane, such as that depicted by formula (IV), with a carbonate source and a dihydroxy aromatic compound such as bisphenol-A, optionally in the presence of a phase transfer catalyst as described above. Suitable conditions are similar to those useful in forming polycarbonates. For example, the copolymers can be prepared by phosgenation at temperatures from below 0° C. to about 100° C., including for example, at temperatures from about 25° C. to about 50° C. Since the reaction is exothermic, the rate of phosgene addition can be used to control the reaction temperature. The amount of phosgene required will generally depend upon the amount of the dihydric reactants. Alternatively, the polycarbonate-polysiloxane copolymers can be prepared by co-reacting, in a molten state, the dihydroxy monomers and a diaryl carbonate ester, such as diphenyl carbonate, in the presence of a transesterification catalyst as described above.

In the production of the polycarbonate-polysiloxane copolymer, the amount of dihydroxy diorganopolysiloxane can be selected so as to provide the desired amount of diorganopolysiloxane units in the copolymer. The particular amounts used will therefore be determined depending on desired physical properties of the composition, the value of x (for example, within the range of about 20 to about 60), and the type and relative amount of each component in the composition, including the type and amount of polycarbonate, type and amount of polycarbonate-polysiloxane copolymer, and type and amount of any other additives. Suitable amounts of dihydroxy diorganopolysiloxane can be determined by one of ordinary skill in the art without undue experimentation using the guidelines taught herein.

For example, according to aspects of the disclosure, the polysiloxane-polycarbonate block copolymer can be provided having any desired level of siloxane content. For example, the siloxane content can be in the range of from 4 mole % to 20 mole %. In additional aspects, the siloxane content of the polysiloxane-polycarbonate block copolymer can be in the range of from 4 mole % to 10 mole %. In still further aspects, the siloxane content of the polysiloxane-polycarbonate block copolymer can be in the range of from 4 mole % to 8 mole %. In a further aspect, the polysiloxane-polycarbonate copolymer comprises a diorganosiloxane content in the range of from 5 to 7 mole wt %. In an even further exemplary aspect, the siloxane content of the polysiloxane-polycarbonate block copolymer can be about 6 mole %. Still further, the diorganopolysiloxane blocks can be randomly distributed in the polysiloxane-polycarbonate block copolymer.

The disclosed polysiloxane-polycarbonate block copolymers can also be end-capped as similarly described in connection with the manufacture of polycarbonates set forth herein. For example, according to aspects of the disclosure, a polysiloxane-polycarbonate block copolymer can be end capped with p-cumyl-phenol.

Useful polycarbonate-polysiloxane copolymers are commercially available and include, but are not limited to, those marketed under the trade name LEXAN® EXL polymers, and are available from SABIC Innovative Plastics (formerly GE Plastics), including blends of LEXAN® EXL polymers with different properties.

In various aspects, the polycarbonate component comprises at least one polycarbonate polymer, wherein the polycarbonate polymer can be a homopolymer, a copolymer, or combinations thereof. In a further aspect, the polycarbonate component comprises two or more polycarbonate polymers. In a still further aspect, the polycarbonate component comprises three or more polycarbonate polymers. In a yet further aspect, the polycarbonate component is a blend of at least two polycarbonate polymers.

In a further aspect, the polycarbonate component is a homopolymer. In a still further aspect, the polycarbonate component is a homopolymer comprising repeating units derived from bisphenol A.

In a further aspect, the polycarbonate component is a copolymer. In a still further aspect, the polycarbonate component is a copolymer comprising repeating units derived from BPA. In yet a further aspect, the polycarbonate component is a copolymer comprising repeating units derived from sebacic acid. In an even further aspect, the polycarbonate component is a copolymer comprising repeating units derived from sebacic acid and BPA.

In a further aspect, the polycarbonate has a weight average molecular weight from about 15,000 to about 50,000 grams/mole, as measured by gel permeation chromatography using BPA polycarbonate standards. In a still further aspect, the polycarbonate has a weight average molecular weight from about 18,000 to about 40,000 grams/mole, as measured by gel permeation chromatography using BPA polycarbonate standards. In yet a further aspect, the polycarbonate has a weight average molecular weight from about 18,000 to about 30,000 grams/mole, as measured by gel permeation chromatography using BPA polycarbonate standards.

In a further aspect, the polycarbonate component comprises a copolymer. In a still further aspect, the polycarbonate component comprises a polycarbonate-polysiloxane copolymer. In a yet further aspect, the polycarbonate-polysiloxane copolymer is a block copolymer. In an even further aspect, the polycarbonate block comprises residues derived from BPA. In a still further aspect, the polycarbonate block is a homopolymer. In a yet further aspect, the polycarbonate block is a homopolymer comprising residues derived from BPA. In an even further aspect, the polycarbonate-polysiloxane copolymer comprises at least one polycarbonate block and at least one polysiloxane block; wherein the polycarbonate block comprises residues derived from BPA; and wherein the polysiloxane block comprises dimethylsiloxane repeating units.

In a further aspect, the polycarbonate component is a copolymer comprising dimethylsiloxane repeating units. In a still further aspect, the polycarbonate component is a polycarbonate-polysiloxane copolymer comprising dimethylsiloxane repeating units.

In a further aspect, the polycarbonate-polysiloxane copolymer comprises a polysiloxane block from about 5 wt % to about 30 wt % of the polycarbonate-polysiloxane copolymer. In an even further aspect, the polycarbonate-polysiloxane copolymer comprises a polysiloxane block from about 15 wt % to about 30 wt % of the polycarbonate-polysiloxane copolymer. In a still further aspect, the polycarbonate-polysiloxane copolymer comprises a polysiloxane block from about 15 wt % to about 25 wt % of the polycarbonate-polysiloxane copolymer. In a yet further aspect, the polycarbonate-polysiloxane copolymer comprises a polysiloxane block from about 17 wt % to about 23 wt % of the polycarbonate-polysiloxane copolymer. In an even further aspect, the polycarbonate-polysiloxane copolymer comprises a polysiloxane block from about 18 wt % to about 22 wt % of the polycarbonate-polysiloxane copolymer. In a still further aspect, the polycarbonate-polysiloxane copolymer comprises a polysiloxane block from about 19 wt % to about 21 wt % of the polycarbonate-polysiloxane copolymer.

In a further aspect, the polycarbonate-polysiloxane copolymer comprises a polysiloxane block having a weight average molecular weight from about 25,000 to about 32,000 Daltons. In a still further aspect, the polycarbonate-polysiloxane copolymer comprises a polysiloxane block having a weight average molecular weight from about 26,000 to about 31,000 Daltons. In a yet further aspect, the polycarbonate-polysiloxane copolymer comprises a polysiloxane block having a weight average molecular weight from about 27,000 to about 30,000 Daltons. In an even further aspect, the polycarbonate-polysiloxane copolymer comprises a polysiloxane block having a weight average molecular weight from about 28,000 to about 30,000 Daltons.

In various aspects, the polycarbonate component comprises a first polycarbonate polymer component and a second polycarbonate polymer component. In a still further aspect, the first polycarbonate polymer component comprises residues derived from BPA. In a yet further aspect, the first polycarbonate polymer component is a homopolymer comprising residues derived from BPA. In an even further aspect, the first polycarbonate polymer component is a high flow polycarbonate. In a still further aspect, the second polycarbonate polymer component comprises residues derived from BPA. In a yet further aspect, the second polycarbonate polymer component is a homopolymer comprising residues derived from BPA. In an even further aspect, the second polycarbonate polymer component is a low flow polycarbonate.

In a further aspect, the first polycarbonate polymer component has a melt flow rate (MFR) of at least about 20 grams/10 minutes when measured at 300° C. and under a load of 1.2 kg according to ASTM D1238. In a still further aspect, the first polycarbonate polymer component has a melt flow rate (MFR) of at least about 22 grams/10 minutes when measured at 300° C. and under a load of 1.2 kg according to ASTM D1238. In a yet further aspect, the first polycarbonate polymer component has a melt flow rate (MFR) from about 17 grams/10 minutes to about 32 grams/10 minutes when measured at 300° C. and under a load of 1.2 kg according to ASTM D1238. In an even further aspect, the first polycarbonate polymer component has a melt flow rate (MFR) from about 20 grams/10 minutes to about 30 grams/10 minutes when measured at 300° C. and under a load of 1.2 kg according to ASTM D1238. In a still further aspect, the first polycarbonate polymer component has a melt flow rate (MFR) from about 22 grams/10 minutes to about 29 grams/10 minutes when measured at 300° C. and under a load of 1.2 kg according to ASTM D1238. In a yet further aspect, the first polycarbonate polymer component has a melt flow rate (MFR) from about 23 grams/10 minutes to about 29 grams/10 minutes when measured at 300° C. and under a load of 1.2 kg according to ASTM D1238.

In a further aspect, the first polycarbonate polymer component has a weight average molecular weight from about 18,000 to about 40,000 grams/mole, as measured by gel permeation chromatography using BPA polycarbonate standards. In a still further aspect, the first polycarbonate polymer component has a weight average molecular weight from about 18,000 to about 35,000 grams/mole, as measured by gel permeation chromatography using BPA polycarbonate standards. In a yet further aspect, the first polycarbonate polymer component has a weight average molecular weight from about 18,000 to about 30,000 grams/mole, as measured by gel permeation chromatography using BPA polycarbonate standards. In an even further aspect, the first polycarbonate polymer component has a weight average molecular weight from about 18,000 to about 25,000 grams/mole, as measured by gel permeation chromatography using BPA polycarbonate standards. In a still further aspect, the first polycarbonate polymer component has a weight average molecular weight from about 18,000 to about 23,000 grams/mole, as measured by gel permeation chromatography using BPA polycarbonate standards.

In a further aspect, the second polycarbonate polymer component has a melt flow rate (MFR) of at least about 3.0 grams/10 minutes when measured at 300° C. and under a load of 1.2 kg according to ASTM D1238. In a still further aspect, the second polycarbonate polymer component has a melt flow rate (MFR) of at least about 4.0 grams/10 minutes when measured at 300° C. and under a load of 1.2 kg according to ASTM D1238. In a yet further aspect, the second polycarbonate polymer component has a melt flow rate (MFR) of at least about 4.5 grams/10 minutes when measured at 300° C. and under a load of 1.2 kg according to ASTM D1238. In an even further aspect, the second polycarbonate polymer component has a melt flow rate (MFR) of at least about 5.0 grams/10 minutes when measured at 300° C. and under a load of 1.2 kg according to ASTM D1238. In a still further aspect, the second polycarbonate polymer component has a melt flow rate (MFR) from about 4.0 grams/10 minutes to about 10.0 grams/10 minutes when measured at 300° C. and under a load of 1.2 kg according to ASTM D1238. In a yet further aspect, the second polycarbonate polymer component has a melt flow rate (MFR) from about 4.5 grams/10 minutes to about 7.2 grams/10 minutes when measured at 300° C. and under a load of 1.2 kg according to ASTM D1238. In an even further aspect, the second polycarbonate polymer component has a melt flow rate (MFR) from about 4.8 grams/10 minutes to about 7.1 grams/10 minutes when measured at 300° C. and under a load of 1.2 kg according to ASTM D1238.

In a further aspect, the second polycarbonate polymer component has a weight average molecular weight from about 18,000 to about 40,000 grams/mole, as measured by gel permeation chromatography using BPA polycarbonate standards. In a still further aspect, the second polycarbonate polymer component has a weight average molecular weight from about 20,000 to about 35,000 grams/mole, as measured by gel permeation chromatography using BPA polycarbonate standards. In a yet further aspect, the second polycarbonate polymer component has a weight average molecular weight from about 20,000 to about 30,000 grams/mole, as measured by gel permeation chromatography using BPA polycarbonate standards. In an even further aspect, the second polycarbonate polymer component has a weight average molecular weight from about 23,000 to about 30,000 grams/mole, as measured by gel permeation chromatography using BPA polycarbonate standards. In a still further aspect, the second polycarbonate polymer component has a weight average molecular weight from about 25,000 to about 30,000 grams/mole, as measured by gel permeation chromatography using BPA polycarbonate standards. In a yet further aspect, the second polycarbonate polymer component has a weight average molecular weight from about 27,000 to about 30,000 grams/mole, as measured by gel permeation chromatography using BPA polycarbonate standards.

In a further aspect, the first polycarbonate component is present in an amount from about 20 wt % to about 70 wt %; and the second polycarbonate component is present in an amount from about 10 wt % to about 40 wt %. In a further aspect, the first polycarbonate component is present in an amount from about 25 wt % to about 60 wt %; and the second polycarbonate component is present in an amount from about 15 wt % to about 40 wt %. In a still further aspect, the first polycarbonate component is present in an amount from about 25 wt % to about 55 wt %; and the second polycarbonate component is present in an amount from about 15 wt % to about 35 wt %.

In various aspects, the polycarbonate component comprises a first polycarbonate polymer component, a second polycarbonate component, and a third polycarbonate component. In a further aspect, the third polycarbonate polymer component is a polycarbonate-polysiloxane copolymer. In a still further aspect, the third polycarbonate polymer component is a polycarbonate-polysiloxane block copolymer. In a yet further aspect, the third polycarbonate polymer component is a polycarbonate-polysiloxane block copolymer, wherein the polycarbonate block comprises residues derived from BPA. In an even further aspect, the third polycarbonate polymer component is a polycarbonate-polysiloxane block copolymer, wherein the polycarbonate block is a homopolymer comprising residues derived from BPA.

In a further aspect, the third polycarbonate polymer component is a polycarbonate-polysiloxane block copolymer, wherein the polysiloxane block comprises dimethylsiloxane repeating units. In a still further aspect, the third polycarbonate polymer component is a polycarbonate-polysiloxane block copolymer, wherein the polysiloxane block is from about 15 wt % to about 30 wt % of the polycarbonate-polysiloxane copolymer. In a yet further aspect, the third polycarbonate polymer component is a polycarbonate-polysiloxane block copolymer, wherein the polysiloxane block is from about 18 wt % to about 24 wt % of the polycarbonate-polysiloxane copolymer.

In a further aspect, the first polycarbonate component is present in an amount from about 20 wt % to about 70 wt %; the second polycarbonate component is present in an amount from about 10 wt % to about 40 wt %; and the third polycarbonate component is present in an amount from about 1 wt % to about 25 wt %. In a still further aspect, the first polycarbonate component is present in an amount from about 25 wt % to about 60 wt %; the second polycarbonate component is present in an amount from about 15 wt % to about 40 wt %; and the third polycarbonate component is present in an amount from about 1 wt % to about 20 wt %. In a yet further aspect, the first polycarbonate component is present in an amount from about 25 wt % to about 55 wt %; the second polycarbonate component is present in an amount from about 15 wt % to about 35 wt %; and the third polycarbonate component is present in an amount from about 1 wt % to about 16 wt %.

### Impact Modifier Component

In one aspect, the disclosed blended thermoplastic compositions of the present invention comprise one or more impact modifier components. In a still further aspect, the disclosed thermoplastic compositions comprise at least one impact modifier. In a yet further aspect, the disclosed thermoplastic compositions comprise two impact modifiers, that is, a first impact modifier component and a second impact modifier component.

In a further aspect, the impact modifiers of the present invention comprise a multi-phase system comprising at least two phases. In one aspect, a two phase system comprises a rubber substrate, with a superstrate (or graft) polymeric material attached to it. This phase is commonly referred to as the “rubber graft phase” because the superstrate is physically attached or grafted to the rubber through chemical reaction. A “rigid matrix phase” or continuous phase is also utilized, where the rubber graft phase (or dispersed phase) is dispersed throughout the matrix phase which forms the polymer continuum. The rubber interface is the surface forming the boundaries between the graft and matrix phases. In a further aspect, the grafted material acts as a compatibilizer between the rubber and the matrix phase at this interface and prevents the separation of these two otherwise immiscible phases. In some aspects, depending upon the type of impact modifier, some of the graft material may remain in free ungrafted form.

In a further aspect, the impact modifier component comprises at least one acrylonitrile-butadiene-styrene (ABS) polymer, at least one methyl methacrylate-butadiene (MB) polymer, or at least one methyl methacrylate-butadiene-styrene (MBS) polymer, or at least one a methyl methacrylate-acrylonitrile-butadiene-styrene (MABS) polymer, or at least one acrylonitrile-styrene-acrylate (ASA) polymer, or combinations thereof. In a still further aspect, the impact modifier component is present in an amount from greater than about 0 wt % to about 20 wt %, based on the total weight of the composition. In a still further aspect, the impact modifier component is present in an amount from about 1 wt % to about 15 wt %. In a yet further aspect, the impact modifier component is present in an amount from about 1 wt % to about 10 wt %. In an even further aspect, the impact modifier component is present in an amount from about 1 wt % to about 5 wt %.

In one aspect, acrylonitrile-butadiene-styrene (“ABS”) graft copolymers contain two or more polymeric parts of different compositions, which are bonded chemically. The graft copolymer is specifically prepared by first polymerizing a conjugated diene, such as butadiene or another conjugated diene, with a monomer copolymerizable therewith, such as styrene, to provide a polymeric backbone. After formation of the polymeric backbone, at least one grafting monomer, and specifically two, are polymerized in the presence of the polymer backbone to obtain the graft copolymer. These resins are prepared by methods well known in the art.

For example, ABS can be made by one or more of emulsion or solution polymerization processes, bulk/mass, suspension and/or emulsion-suspension process routes. In addition, ABS materials can be produced by other process techniques such as batch, semi batch and continuous polymerization for reasons of either manufacturing economics or product performance or both. In order to reduce point defects or inclusions in the inner layer of the final multi-layer article, the ABS is produced by bulk polymerized.

Emulsion polymerization of vinyl monomers gives rise to a family of addition polymers. In many instances the vinyl emulsion polymers are copolymers containing both rubbery and rigid polymer units. Mixtures of emulsion resins, especially mixtures of rubber and rigid vinyl emulsion derived polymers are useful in blends.

Such rubber modified thermoplastic resins made by an emulsion polymerization process can comprise a discontinuous rubber phase dispersed in a continuous rigid thermoplastic phase, wherein at least a portion of the rigid thermoplastic phase is chemically grafted to the rubber phase. Such a rubbery emulsion polymerized resin can be further blended with a vinyl polymer made by an emulsion or bulk polymerized process. However, at least a portion of the vinyl polymer, rubber or rigid thermoplastic phase, blended with polycarbonate, will be made by emulsion polymerization.

Suitable rubbers for use in making a vinyl emulsion polymer blend are rubbery polymers having a glass transition temperature (Tg) of less than or equal to 25° C., more preferably less than or equal to 0° C., and even more preferably less than or equal to −30° C. As referred to herein, the Tg of a polymer is the Tg value of polymer as measured by differential scanning calorimetry (heating rate 20° C./minute, with the Tg value being determined at the inflection point). In another embodiment, the rubber comprises a linear polymer having structural units derived from one or more conjugated diene monomers. Suitable conjugated diene monomers include, e.g., 1,3-butadiene, isoprene, 1,3-heptadiene, methyl-1,3-pentadiene, 2,3-dimethylbutadiene, 2-ethyl-1,3-pentadiene, 1,3-hexadiene, 2,4-hexadiene, dichlorobutadiene, bromobutadiene and dibromobutadiene as well as mixtures of conjugated diene monomers. In a preferred embodiment, the conjugated diene monomer is 1,3-butadiene.

The emulsion polymer may, optionally, include structural units derived from one or more copolymerizable monoethylenically unsaturated monomers selected from (C₂-C₁₂) olefin monomers, vinyl aromatic monomers and monoethylenically unsaturated nitrile monomers, (C₂-C₁₂) alkyl(meth)acrylate, (C₁-C₁₂) alkyl acrylate, and (C₁-C₁₂) alkyl (C₁-C₈) alkylacrylate monomers, polyethylenically unsaturated monomers, and mixtures thereof.

As used herein, the term “(C₂-C₁₂) olefin monomers” means a compound having from 2 to 12 carbon atoms per molecule and having a single site of ethylenic unsaturation per molecule. Suitable (C₂-C₁₂) olefin monomers include, e.g., ethylene, propene, 1-butene, 1-pentene, heptene, 2-ethyl-hexylene, 2-ethyl-heptene, 1-octene, and 1-nonene.

As used herein, the term “monoethylenically unsaturated” means having a single site of ethylenic unsaturation per molecule, the term “(meth)acrylate monomers” refers collectively to acrylate monomers and methacrylate monomers, and the term “alkyl acrylate monomers” refers collectively to vinyl carboxylic acid ester acrylate monomers and alkylacrylate monomers and the terminology “(Cx-Cy)”, as applied to a particular unit, such as, for example, a chemical compound or a chemical substituent group, means having a carbon atom content of from x carbon atoms to y carbon atoms per such unit, for example, “(C₁-C₁₂)alkyl” means a straight or branched alkyl substituent group having from 1 to 12 carbon atoms per group and includes, e.g., methyl, ethyl, n-butyl, isobutyl, sec-butyl, t-butyl, n-propyl, isopropyl, pentyl, hexyl, heptyl, octyl, nonyl, decyl, undecyl and dodecyl.

The rubber phase and the rigid thermoplastic phase of the emulsion modified vinyl polymer may, optionally include structural units derived from one or more other copolymerizable monoethylenically unsaturated monomers such as, e.g., monoethylenically unsaturated carboxylic acids such as, e.g., acrylic acid, methacrylic acid, itaconic acid, hydroxy (C₁-C₁₂) alkyl(meth)acrylate monomers such as, e.g., hydroxyethyl methacrylate; (C₅-C₁₂) cycloalkyl(meth)acrylate monomers such as e.g., cyclohexyl methacrylate; (meth)acrylamide monomers such as e.g., acrylamide and methacrylamide; maleimide monomers such as, e.g., N-alkyl maleimides, N-aryl maleimides, maleic anhydride, vinyl esters such as, e.g., vinyl acetate and vinyl propionate. As used herein, the term “(C₅-C₁₂) cycloalkyl” means a cyclic alkyl substituent group having from 5 to 12 carbon atoms per group and the term “(meth)acrylamide” refers collectively to acrylamides and methacrylamides.

In some cases the rubber phase of the emulsion polymer is derived from polymerization of a butadiene, C₄-C₁₂ acrylates or combination thereof with a rigid phase derived from polymerization of styrene, C₁-C₃ acrylates, methacrylates, acrylonitrile or combinations thereof where at least a portion of the rigid phase is grafted to the rubber phase. In other instances more than half of the rigid phase will be grafted to the rubber phase.

Suitable vinyl aromatic monomers include, e.g., styrene and substituted styrenes having one or more alkyl, alkoxyl, hydroxyl or halo substituent group attached to the aromatic ring, including, e.g., -methyl styrene, p-methyl styrene, vinyl toluene, vinyl xylene, trimethyl styrene, butyl styrene, chlorostyrene, dichlorostyrene, bromostyrene, p-hydroxystyrene, methoxystyrene and vinyl-substituted condensed aromatic ring structures, such as, e.g., vinyl naphthalene, vinyl anthracene, as well as mixtures of vinyl aromatic monomers. As used herein, the term “monoethylenically unsaturated nitrile monomer” means an acyclic compound that includes a single nitrile group and a single site of ethylenic unsaturation per molecule and includes, e.g., acrylonitrile, methacrylonitrile, a-chloro acrylonitrile.

As used herein, the term “polyethylenically unsaturated” means having two or more sites of ethylenic unsaturation per molecule. In one aspect, a polyethylenically unsaturated monomer is used in the alkyl acrylate rubbers to provide “crosslinking” of the poly(alkyl acrylate) rubber particles formed in the process and to provide “graftlinking” sites in the poly(alkyl acrylate) rubber for subsequent reaction with grafting monomers. In further aspects, the polyethylenically unsaturated crosslinking monomers contain at least two ethylenically unsaturated sites per molecule that have a reactivity that is similar, under the polymerization conditions utilized, to that of the monoethylenically unsaturated alkyl acrylate monomer. In still further aspects, the graftlinking monomers include those monomers having at least one site of ethylenic unsaturation that have a reactivity that is similar, under the emulsion or other polymerization conditions used, to that of the alkyl acrylate monomer and at least one other site of ethylenic unsaturation having a reactivity that is substantially different, under the emulsion polymerization conditions used in the process of the present invention, from that of the monoethylenically unsaturated alkyl acrylate monomer, so that at least one unsaturated site per molecule of graftlinking monomer reacts during synthesis of the rubber latex and at least one other unsaturated site per molecule of graftlinking monomer remains unreacted following synthesis of the rubber latex and is thus remains available for subsequent reaction under different reaction conditions. Non-limiting examples of polyethylenically unsaturated monomers include butylene diacrylate, divinyl benzene, butene diol dimethacrylate, trimethylolpropane tri(meth)acrylate, allyl methacrylate, diallyl maleate, triallyl cyanurate and mixtures thereof. In one aspect, triallyl cyanurate is used as both a crosslinking monomer and a graftlinking monomer

In an alternative embodiment, the rubber is a copolymer, preferably a block copolymer, comprising structural units derived from one or more conjugated diene monomers and up to 90 percent by weight (“wt %”) structural units derived from one or more monomers selected from vinyl aromatic monomers and monoethylenically unsaturated nitrile monomers, such as, a styrene-butadiene copolymer, an acrylonitrile-butadiene copolymer or a styrene-butadiene-acrylonitrile copolymer. In another embodiment, the rubber is a styrene-butadiene block copolymer that contains from 50 to 95 wt % structural units derived from butadiene and from 5 to 50 wt % structural units derived from styrene.

The emulsion derived polymers can be further blended with non-emulsion polymerized vinyl polymers, such as those made with bulk or mass polymerization techniques. A process to prepare mixtures containing polycarbonate, an emulsion derived vinyl polymer, along with a bulk polymerized vinyl polymers, is also contemplated.

The rubber phase can be made by aqueous emulsion polymerization in the presence of a radical initiator, a surfactant and, optionally, a chain transfer agent and coagulated to form particles of rubber phase material. Suitable initiators include conventional free radical initiator such as, e.g., an organic peroxide compound, such as e.g., benzoyl peroxide, a persulfate compound, such as, e.g., potassium persulfate, an azonitrile compound such as, e.g., 2,2′-azobis-2,3,3-trimethylbutyronitrile, or a redox initiator system, such as, e.g., a combination of cumene hydroperoxide, ferrous sulfate, tetrasodium pyrophosphate and a reducing sugar or sodium formaldehyde sulfoxylate. Suitable chain transfer agents include, for example, a (C₉-C₁₃) alkyl mercaptan compound such as nonyl mercaptan, t-dodecyl mercaptan. Suitable emulsion aids include, linear or branched carboxylic acid salts, with about 10 to 30 carbon atoms. Suitable salts include ammonium carboxylates and alkaline carboxylates; such as ammonium stearate, methyl ammonium behenate, triethyl ammonium stearate, sodium stearate, sodium isostearate, potassium stearate, sodium salts of tallow fatty acids, sodium oleate, sodium palmitate, potassium linoleate, sodium laurate, potassium abieate (rosin acid salt), sodium abietate and combinations thereof. Often mixtures of fatty acid salts derived from natural sources such as seed oils or animal fat (such as tallow fatty acids) are used as emulsifiers.

In one aspect, the emulsion polymerized particles of rubber phase material have a weight average particle size of 50 to 800 nanometers (“nm”), more preferably, of from 100 to 500 nm, as measured by light transmission. The size of emulsion polymerized rubber particles can optionally be increased by mechanical, colloidal or chemical agglomeration of the emulsion polymerized particles, according to known techniques.

In a further aspect, acrylonitrile-butadiene-styrene copolymer has an average particle size from about 500 nm to about 1500 nm. In a still further aspect, acrylonitrile-butadiene-styrene copolymer has an average particle size from about 750 nm to about 1250 nm. In a yet further aspect, acrylonitrile-butadiene-styrene copolymer has an average particle size from about 900 nm to about 1100 nm.

The rigid thermoplastic phase comprises one or more vinyl derived thermoplastic polymers and exhibits a Tg of greater than 25° C., preferably greater than or equal to 90° C. and even more preferably greater than or equal to 100° C.

In various aspects, the rigid thermoplastic phase comprises a vinyl aromatic polymer having first structural units derived from one or more vinyl aromatic monomers, preferably styrene, and having second structural units derived from one or more monoethylenically unsaturated nitrile monomers, preferably acrylonitrile. In other cases, the rigid phase comprises from 55 to 99 wt %, still more preferably 60 to 90 wt %, structural units derived from styrene and from 1 to 45 wt %, still more preferably 10 to 40 wt %, structural units derived from acrylonitrile.

The amount of grafting that takes place between the rigid thermoplastic phase and the rubber phase can vary with the relative amount and composition of the rubber phase. In one embodiment, from 10 to 90 wt %, often from 25 to 60 wt %, of the rigid thermoplastic phase is chemically grafted to the rubber phase and from 10 to 90 wt %, preferably from 40 to 75 wt % of the rigid thermoplastic phase remains “free”, i.e., non-grafted.

The rigid thermoplastic phase of the rubber modified thermoplastic resin can be formed solely by emulsion polymerization carried out in the presence of the rubber phase or by addition of one or more separately polymerized rigid thermoplastic polymers to a rigid thermoplastic polymer that has been polymerized in the presence of the rubber phase. In one embodiment, the weight average molecular weight of the one or more separately polymerized rigid thermoplastic polymers is from about 50,000 to about 250,000 g/mol.

In other cases, the rubber modified thermoplastic resin comprises a rubber phase having a polymer with structural units derived from one or more conjugated diene monomers, and, optionally, further comprising structural units derived from one or more monomers selected from vinyl aromatic monomers and monoethylenically unsaturated nitrile monomers, and the rigid thermoplastic phase comprises a polymer having structural units derived from one or more monomers selected from vinyl aromatic monomers and monoethylenically unsaturated nitrile monomers. In one embodiment, the rubber phase of the rubber modified thermoplastic resin comprises a polybutadiene or poly(styrene-butadiene) rubber and the rigid thermoplastic phase comprises a styrene-acrylonitrile copolymer. Vinyl polymers free of alkyl carbon-halogen linkages, specifically bromine and chlorine carbon bond linkages can provide melt stability.

In some aspects, the rubbers are cross-linked poly(alkyl acrylate) rubbers and poly(alkyl alkylacrylate) rubbers. In other aspects, the rubbers are poly(butyl acrylate), poly(ethyl acrylate) and poly(2-ethylhexyl acrylate) rubbers. In further aspects, the rubber is poly(butyl acrylate) rubber, particularly poly(n-butyl acrylate) rubber. In further aspects, in addition to or in place of the acrylate, styrene and acrylonitrile monomers used in the graft or matrix resins, monomers including vinyl carboxylic acids such as acrylic acid, methacrylic acid and itaconic acid, acrylamides such as acrylamide, methacrylamide and n-butyl acrylamide, alpha-, beta-unsaturated dicarboxylic anhydrides such as maleic anhydride and itaconic anhydride, imides of alpha-, beta-unsaturated dicarboxylic acids such as maleimide, N-methylmaleimide, N-ethylmaleimide, N-alkyl maleimide, N-aryl maleimide and the halo substituted N-alkyl N-aryl maleimides, imidized polymethyl methacrylates (polyglutarimides), unsaturated ketones such as vinyl methyl ketone and methyl isopropenyl ketone, alpha-olefins such as ethylene and propylene, vinyl esters such as vinyl acetate and vinyl stearate, vinyl and vinylidene halides such as the vinyl and vinylidene chlorides and bromides, vinyl-substituted condensed aromatic ring structures such as vinyl naphthalene and vinyl anthracene and pyridine monomers may be used, either alone or as a mixture of two or more kinds.

In some instances it is desirable to isolate the emulsion vinyl polymer or copolymer by coagulation in acid. In such instances the emulsion polymer can be contaminated by residual acid, or species derived from the action of such acid, for example carboxylic acids derived from fatty acid soaps used to form the emulsion. The acid used for coagulation can be a mineral acid; such as sulfuric acid, hydrochloric acid, nitric acid, phosphoric acid or mixtures thereof. In some cases the acid used for coagulation has a pH less than about 5.

Exemplary elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), methyl methacrylate-butadiene (MB) and styrene-acrylonitrile (SAN).

In another aspect, acrylonitrile-styrene-acrylate (ASA) graft copolymers comprise a two phase system comprising an acrylate rubber substrate, for example poly(butyl acrylate) rubber, with a superstate (or graft) copolymer of styrene-acrylonitrile (SAN) attached to it. In a further aspect, the rubber graft phase (or dispersed phase) is dispersed throughout the “rigid matrix phase” or continuous phase, which forms the polymer continuum. In one aspect, the matrix phase utilized is polymethyl methacrylate (PMMA) or methyl methacrylate-styrene-acrylonitrile (MMASAN), or a combination thereof.

In further aspects, ASA graft copolymers are graft copolymers of vinyl carboxylic acid ester monomers, vinyl aromatic monomers and vinyl cyanide monomers, including the group of polymers derived from vinyl carboxylic acid ester monomers, vinyl aromatic monomers and vinyl cyanide monomers. Examples of vinyl carboxylic acid ester monomers include butyl acrylate, methyl methacrylate, methyl acrylate, ethyl methacrylate, ethyl acrylate, butyl methacrylate, propyl methacrylate, propyl acrylate, hexyl methacrylate, 2-ethylhexyl acrylate, 2-ethylhexyl methacrylate, decyl methacrylate, methyl ethacrylate, butyl ethacrylate, cyclohexyl methacrylate, methoxyethyl acrylate, hydroxyethyl methacrylate and mixtures thereof. Examples of substituted vinyl aromatic monomers include styrene, 4-methyl-styrene, vinyl xylene, trimethyl-styrene, 3,5-diethyl-styrene, p-tert-butyl-styrene, 4-n-propyl-styrene, α-methyl-styrene, α-ethyl-styrene, α-methyl-p-methyl-styrene, p-hydroxy-styrene, methoxy-styrenes, chloro-styrene, 2-methyl-4-chloro-styrene, bromo-styrene, α-chloro-styrene, α-bromo-styrene, dichloro-styrene, 2,6-dichloro-4-methyl-styrene, dibromo-styrene, tetrachloro-styrene and mixtures thereof.

As used herein, the term “monomers” includes all of the polymerizable species of monomers and copolymers typically utilized in polymerization reactions, including, but not limited to homopolymers of primarily a single monomer, copolymers of two or more monomers, terpolymers of three monomers and physical mixtures thereof.

In a further aspect, Various monomers may be further utilized in addition to or in place of those listed above to further modify various properties of the compositions disclosed herein. In general, the components of the present invention may be compounded with a copolymerizable monomer or monomers within a range not damaging the objectives and advantages of this invention.

In a further aspect, the impact modifier component comprises one more of an acrylonitrile butadiene styrene (“ABS”) copolymer, a methacrylate butadiene styrene (“MBS”) copolymer, a methyl methacrylate butadiene (“MB”) copolymer, a bulk polymerized ABS (“BABS”) copolymer, and an acrylonitrile-styrene-acrylate (“ASA”) copolymer. In a still further aspect, the impact modifier component comprises an acrylonitrile butadiene styrene (“ABS”) copolymer. In a yet further aspect, the impact modifier component comprises a methyl methacrylate butadiene styrene (“MBS”) copolymer. In an even further aspect, the impact modifier component comprises a bulk polymerized ABS (“BABS”) copolymer. In a still further aspect, the impact modifier component comprises a methyl methacrylate butadiene (“MB”) copolymer. In a yet further aspect, the impact modifier component comprises an acrylonitrile-styrene-acrylate (“ASA”) copolymer.

In a further aspect, the impact modifier component is present in an amount from about 2 wt % to about 10 wt %. In a still further aspect, the impact modifier component is present in an amount from about 4 wt % to about 8 wt %. In a yet further aspect, the impact modifier component is present in an amount from about 4 wt % to about 6 wt %. In an even further aspect, the impact modifier component is present in an amount from about 2 wt % to about 9 wt %. In a still further aspect, the impact modifier component is present in an amount from about 1 wt % to about 6 wt %. In a yet further aspect, the impact modifier component is present in an amount from about 2 wt % to about 5 wt %. In an even further aspect, the impact modifier component is present in an amount from about 2 wt % to about 4 wt %.

In a further aspect, the impact modifier component is present in an amount from about 2 wt % to about 50 wt %. In a still further aspect, the impact modifier component is present in an amount from about 2 wt % to about 45 wt %. In a yet further aspect, the impact modifier component is present in an amount from about 2 wt % to about 40 wt %. In an even further aspect, the impact modifier component is present in an amount from about 8 wt % to about 50 wt %. In a still further aspect, the impact modifier component is present in an amount from about 8 wt % to about 45 wt %. In a yet further aspect, the impact modifier component is present in an amount from about 8 wt % to about 40 wt %. In an even further aspect, the impact modifier component is present in an amount from about 8 wt % to about 35 wt %. In a still further aspect, the impact modifier component is present in an amount from about 2 wt % to about 20 wt %. In a yet further aspect, the impact modifier component is present in an amount from about 2 wt % to about 18 wt %. In an even further aspect, the impact modifier component is present in an amount from about 2 wt % to about 15 wt %.

In a further aspect, the impact modifier component is present in an amount from about 20 wt % to about 70 wt %. In a still further aspect, the impact modifier component is present in an amount from about 20 wt % to about 65 wt %. In a yet further aspect, the impact modifier component is present in an amount from about 20 wt % to about 60 wt %. In an even further aspect, the impact modifier component is present in an amount from about 25 wt % to about 65 wt %. In a still further aspect, the impact modifier component is present in an amount from about 25 wt % to about 55 wt %. In a yet further aspect, the impact modifier component is present in an amount from about 25 wt % to about 50 wt %. In an even further aspect, the impact modifier component is present in an amount from about 20 wt % to about 50 wt %.

In one aspect, the impact modifier component comprises a methacrylate-butadiene-styrene (MBS) polymer composition. In another aspect, the MBS polymer composition is present in an amount from about 2 wt % to about 10 wt %. In still another aspect, the MBS polymer composition is present in an amount from about 2 wt % to about 9 wt %. In still another aspect, the MBS polymer composition is present in an amount from about 2 wt % to about 8 wt %.

In one aspect, the MBS polymer composition is present in an amount from about 2 wt % to about 10 wt %. In another aspect, the MBS polymer composition is present in an amount from about 2 wt % to about 8 wt %. In still another aspect, the MBS polymer composition is present in an amount from about 2 wt % to about 6 wt %. In still another aspect, the MBS polymer composition is present in an amount from about 2 wt % to about 5 wt %. In still another aspect, the MBS polymer composition is present in an amount from about 2 wt % to about 4 wt %.

In one aspect, the MBS polymer composition comprises butadiene content from about 50 wt % to about 80 wt %. In another aspect, the MBS polymer composition comprises butadiene content from about 60 wt % to about 80 wt %. In still another aspect, the MBS polymer composition comprises butadiene content from about 70 wt % to about 80 wt %. In still another aspect, the MBS polymer composition comprises butadiene content from about 70 wt % to about 74 wt %. In still another aspect, the MBS polymer composition comprises butadiene content from about 70 wt % to about 75 wt %.

In one aspect, the MBS polymer composition has a bulk density from about 0.25 g/cm³ to about 0.55 g/cm³. In another aspect, the MBS polymer composition has a bulk density from about 0.30 g/cm³ to about 0.50 g/cm³. In still another aspect, the MBS polymer composition has a bulk density from about 0.35 g/cm³ to about 0.49 g/cm³. In still another aspect, the MBS polymer composition has a bulk density from about 0.35 g/cm³ to about 0.50 g/cm³.

In one aspect, the MBS polymer composition has a maximum mean particle diameter of about 250 μm. In another aspect, the MBS polymer composition has a maximum mean particle diameter of about 260 μm. In still another aspect, the MBS polymer composition has a maximum mean particle diameter of about 270 μm. In still another aspect, the MBS polymer composition has a maximum mean particle diameter of about 280 μm. In still another aspect, the MBS polymer composition has a maximum mean particle diameter of about 290 μm. In still another aspect, the MBS polymer composition has a maximum mean particle diameter of about 300 μm.

In one aspect, the MBS polymer composition has a maximum mean particle diameter from about 200 μm to about 300 μm. In another aspect, the MBS polymer composition has a maximum mean particle diameter from about 210 μm to about 290 μm. In still another aspect, the MBS polymer composition has a maximum mean particle diameter from about 220 μm to about 280 μm. In still another aspect, the MBS has a maximum mean particle diameter from about 230 μm to about 270 μm.

In one aspect, the impact modifier component comprises a methacrylate-butadiene (MB) polymer composition. In another aspect, the MB polymer composition is present in an amount from about 2 wt % to about 10 wt %. In still another aspect, the MB polymer composition is present in an amount from about 2 wt % to about 9 wt %. In still another aspect, the MB polymer composition is present in an amount from about 2 wt % to about 8 wt %.

In one aspect, the MB polymer composition is present in an amount from about 2 wt % to about 10 wt %. In another aspect, the MB polymer composition is present in an amount from about 2 wt % to about 8 wt %. In still another aspect, the MB polymer composition is present in an amount from about 2 wt % to about 6 wt %. In still another aspect, the MB polymer composition is present in an amount from about 2 wt % to about 5 wt %. In still another aspect, the MB polymer composition is present in an amount from about 2 wt % to about 4 wt %.

In one aspect, the MB polymer composition comprises butadiene content from about 50 wt % to about 80 wt %. In another aspect, the MB polymer composition comprises butadiene content from about 60 wt % to about 80 wt %. In still another aspect, the MB polymer composition comprises butadiene content from about 70 wt % to about 80 wt %. In still another aspect, the MB polymer composition comprises butadiene content from about 70 wt % to about 74 wt %. In still another aspect, the MB polymer composition comprises butadiene content from about 70 wt % to about 75 wt %.

In one aspect, the impact modifier comprises an acrylonitrile-butadiene-styrene (ABS) polymer composition. In another aspect, the ABS polymer composition is an emulsion polymerized ABS. In still another aspect, the ABS polymer composition is a bulk-polymerized ABS. In yet another aspect, the ABS polymer composition comprises grafted SAN and free SAN. In still another aspect, the ABS polymer composition is a SAN-grafted emulsion ABS.

In a further aspect, the ABS polymer composition is present in an amount from about 2 wt % to about 50 wt %. In a still further aspect, the ABS polymer composition is present in an amount from about 2 wt % to about 45 wt %. In a yet further aspect, the ABS polymer composition is present in an amount from about 2 wt % to about 40 wt %. In an even further aspect, the ABS polymer composition is present in an amount from about 8 wt % to about 50 wt %. In a still further aspect, the ABS polymer composition is present in an amount from about 8 wt % to about 45 wt %. In a yet further aspect, the ABS polymer composition is present in an amount from about 8 wt % to about 40 wt %. In an even further aspect, the ABS polymer composition is present in an amount from about 8 wt % to about 35 wt %. In a still further aspect, the ABS polymer composition is present in an amount from about 2 wt % to about 20 wt %. In a yet further aspect, the ABS polymer composition is present in an amount from about 2 wt % to about 18 wt %. In an even further aspect, the ABS polymer composition is present in an amount from about 2 wt % to about 15 wt %.

In one aspect, ABS polymer composition comprises butadiene content from about 20 wt % to about 75 wt %. In still another aspect, ABS polymer composition comprises butadiene content from about 30 wt % to about 65 wt %. In still another aspect, ABS polymer composition comprises butadiene content from about 40 wt % to about 55 wt %. In still another aspect, ABS polymer composition comprises butadiene content from about 10 wt % to about 25 wt %. In still another aspect, ABS polymer composition comprises acrylonitrile content from about 5 wt % to about 25 wt %. In still another aspect, ABS polymer composition comprises acrylonitrile content from about 7 wt % to about 17 wt %.

In one aspect, the impact modifier comprises an acrylonitrile-styrene-acrylate (ASA) polymer composition. In another aspect, the ASA polymer composition comprises a rigid matrix phase comprising a terpolymer derived from monomers selected from the group consisting of vinyl carboxylic acid ester monomers, vinyl aromatic monomers and unsaturated nitrile monomers. In another aspect, the mixture comprises polymethyl methacrylate (PMMA) homopolymer and methyl methacrylate-styrene-acrylonitrile (MMASAN) terpolymer.

In a further aspect, the ASA polymer composition is present in an amount from about 20 wt % to about 70 wt %. In a still further aspect, the ASA polymer composition is present in an amount from about 20 wt % to about 65 wt %. In a yet further aspect, the ASA polymer composition is present in an amount from about 25 wt % to about 70 wt %. In an even further aspect, the ASA polymer composition is present in an amount from about 25 wt % to about 65 wt %. In a still further aspect, the ASA polymer composition is present in an amount from about 25 wt % to about 60 wt %. In a yet further aspect, the ASA polymer composition is present in an amount from about 20 wt % to about 55 wt %. In an even further aspect, the ASA polymer composition is present in an amount from about 20 wt % to about 50 wt %.

In one aspect, the ASA polymer composition comprises about 10 percent to about 40 percent of poly(butyl acrylate) rubber. In another aspect, about 15 percent to about 30 percent. In yet another aspect, about 15 percent and 25 percent rubber.

In another aspect, the ASA polymer composition comprises a rubber graft phase comprising 20% poly(butyl acrylate) to about 70% poly(butyl acrylate). In another aspect, the rubber graft phase comprises about 45% poly(butyl acrylate) rubber and 55% SAN, with the SAN portion of the graft phase made from 65% styrene and 35% acrylonitrile to 75% styrene and 25% acrylonitrile. In yet another aspect, the SAN portion of the graft phase comprises about 70-75% styrene and about 25-30% acrylonitrile.

In one aspect, the ASA polymer composition comprises MMASAN comprising 80% MMA, 15% Styrene and 5% Acrylonitrile. In another aspect, the MMASAN comprises about 60% MMA, 30% Styrene and 10% Acrylonitrile. In yet another aspect, the MMASAN comprises about 45% methyl methacrylate, 40% styrene and 15% acrylonitrile. In still another aspect, the PMMA/MMASAN ratio in the matrix phase copolymer ranges from about 20/80 to about 80/20; and in another aspect, from 25/75 to about 75/25 including 50/50.

In another aspect, the ASA polymer composition comprises ratios of graft phase to matrix phase of from 15/85 to 75/25, and in another aspect, about 45% graft phase and 55% matrix phase. The graft copolymer phase may be coagulated, blended and colloided with the matrix phase homopolymers, copolymers and/or terpolymers by the various blending processes which are well known in the art to form the ASA polymer blend.

In one aspect, exemplary ASA polymer compositions include ASA GELOY resins (available from SABIC IP) and PARALOID EXL impact modifiers (available from DOW Chemical Co.).

As used herein, a silicone rubber impact modifier means a resin prepared by graft copolymerization of a mixture of a first rubber latex of polyorganosiloxane and a second rubber latex of polyalkylacrylate and/or polyalkylmethacrylate, with a vinyl monomer containing a methacrylic acid ester. Exemplary silicone rubber impact modifiers can be prepared in accordance with the method of Sasaki et al, U.S. Pat. No. 5,132,359, which is incorporated by reference in its entirety.

In addition to the foregoing components, the impact modifier compositions can optionally comprise one or more additive materials. Combinations of additives can be used. Such additives can be mixed at a suitable time during the mixing of the components for forming the impact modifier composition. Exemplary and non-limiting examples of additive materials that can be present in the impact modifier compositions include processing agents, stabilizers, or neutralizers, or any combination thereof.

### Flame Retardant Component

In one aspect, the blended thermoplastic compositions of the present invention can comprise a flame retardant, wherein the flame retardant comprises any flame retardant material or mixture of flame retardant materials suitable for use in the inventive composition. In various aspects, the flame retardant component comprises a phosphate containing material. In a further aspect, the flame retardant component comprises an oligomeric phosphate, polymeric phosphate, mixed phosphate/phosphonate or a combination thereof.

In a further aspect, the flame retardant component comprises a solid bis-phosphate component, such as an aryl bis-phosphate in solid form. In various aspects, a solid flame retardant is employed in place of a liquid flame retardant to improve and/or maintain physical properties of the composition, such as impact strength and/or heat deflection temperature (HDT). However, the enhanced physical properties in formulations using solid flame retardants as compared to liquid flame retardants also results in a loss in melt flow. In one aspect, the flame retardant component comprises a solid flame retardant that improves physical properties while maintaining flow.

In a further aspect, the flame retardant component is an oligomeric aryl phosphate ester, wherein the oligomeric phosphate ester is a free flowing powder at 23° C. In a still further aspect, the flame retardant is a oligomeric alkaryl phosphate ester flame, wherein the oligomeric phosphate ester is a free flowing powder at 23° C. In various aspects, an example of a suitable flame retardant component includes, but is not limited to Fyroflex™ Sol-DP (commercially available from ICL-IP, Inc., Ardsley, N.Y.). In further aspects, the flame retardant component is Fyroflex™ Sol-DP (commercially available from ICL-IP, Inc., Ardsley, N.Y.).

In a further aspect, the flame retardant component comprises a solid flame retardant that improves physical properties at room temperatures and low temperatures while improving melt flow and/or flame performance. In a still further aspect, the solid flame retardant mixed and/or blended with the polycarbonate component and impact modifier component can comprise a polymer system capable of maintaining and/or improving the flow performance of the resulting material. In a yet further aspect, the solid bis-phosphate flame retardants, when employed in polycarbonate formulations, impart improved physical properties such as, impact strength and ductility at low temperature, and heat deflection temperature (HDT) to the formulations as compared with commonly used liquid oligomeric bis-phosphate containing flame retardant polycarbonate compositions.

The concentration of the flame retardant component can vary, and the present invention is not intended to be limited to any particular flame retardant concentration. In one aspect, the disclosed composition comprises from about 0 wt % to about 20 wt % of the flame retardant component, for example, about 1, 2, 3, 4, 5, 6, 7, 8, 9, 10, 11, 12, 13, 14, 15, 16, 17, 18, 19, or 20 wt %. In other aspects, the inventive composition comprises from about 4 wt % to about 15 wt % of flame retardant component, for example, about 4, 4.5, 5, 5.5, 6, 6.5, 7, 7.5, 8, 8.5, 9, 9.5, 10, 10.5, 11, 11.5, 12, 12.5, 13, 13.5, 14, 14.5, or 15 wt %. In one aspect, the composition comprises about 8 wt % flame retardant component, such as, hydroquinone bis-(diphenylphosphate). In another aspect, the composition comprises about 10 wt % flame retardant component, such as, hydroquinone bis-(diphenylphosphate). In still another aspect, the composition comprises about 11 wt % flame retardant component, such as, hydroquinone bis-(diphenylphosphate). In a further aspect, the flame retardant component is present in an amount from about 1 wt % to about 15 wt %. In a still further aspect, the flame retardant component is present in an amount from about 4 wt % to about 12 wt %. In a yet further aspect, the flame retardant component is present in an amount from about 2 wt % to about 10 wt %.

### Optional Polymer Composition Additives

In addition to the foregoing components, the disclosed blended thermoplastic compositions can optionally comprise a balance amount of one or more additive materials ordinarily incorporated in polycarbonate resin compositions of this type, with the proviso that the additives are selected so as to not significantly adversely affect the desired properties of the polycarbonate composition. Combinations of additives can be used. Such additives can be mixed at a suitable time during the mixing of the components for forming the composition. Exemplary and non-limiting examples of additive materials that can be present in the disclosed polycarbonate compositions include an acid scavenger, anti-drip agent, antioxidant, antistatic agent, chain extender, colorant (e.g., pigment and/or dye), de-molding agent, fillers, flow promoter, lubricant, mold release agent, plasticizer, quenching agent, stabilizer (including for example a thermal stabilizer, a hydrolytic stabilizer, or a light stabilizer), UV absorbing additive, and UV reflecting additive, or any combination thereof.

In a further aspect, the disclosed blended thermoplastic compositions can further comprise a filler component. In one aspect, mineral fillers are used in engineering a variety of thermoplastics to provide high performance properties, including improved impact properties while maintaining good ductility together with good flow. Examples of suitable mineral fillers include any materials known for these uses, provided that they do not adversely affect the desired properties. For example, suitable mineral fillers include talc, including fibrous, modular, needle shaped, lamellar talc, or the like; surface-treated talc; wollastonite; surface-treated wollastonite; or combinations thereof. In a further aspect, the filler component can be present in an amount from about 5 wt % to about 30 wt %. In a still further aspect, the filler component can be present in an amount from about 5 wt % to about 25 wt %. In a yet further aspect, the filler component can be present in an amount from about 10 wt % to about 25 wt %.

In a further aspect, the disclosed blended thermoplastic compositions can further comprise a primary antioxidant or “stabilizer” (e.g., a hindered phenol) and, optionally, a secondary antioxidant (e.g., a phosphate and/or thioester). Suitable antioxidant additives include, for example, organic phosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants.

In a further aspect, the antioxidant is a primary antioxidant, a secondary antioxidant, or combinations thereof. In a still further aspect, the primary antioxidant is selected from a hindered phenol and secondary aryl amine, or a combination thereof. In yet a further aspect, the hindered phenol comprises one or more compounds selected from triethylene glycol bis[3-(3-t-butyl-5-methyl-4-hydroxyphenyl)propionate], 1,6-hexanediol bis[3-(3,5-di-t-butyl-4-hydroxyphenyl)propionate], 2,4-bis(n-octylthio)-6-(4-hydroxy-3,5-di-t-butylanilino)-1,3,5-triazine, pentaerythrityl tetrakis[3-(3,5-di-t-butyl-4-hydroxyphenyl)propionate], 2,2-thiodiethylene bis[3-(3,5-di-t-butyl-4-hydroxyphenyl)propionate], octadecyl 3-(3,5-di-t-butyl-4-hydroxyphenyl)propionate, N,N′-hexamethylene bis(3,5-di-t-butyl-4-hydroxy-hydrocinnamamide), tetrakis(methylene 3,5-di-tert-butyl-hydroxycinnamate)methane, and octadecyl 3,5-di-tert-butylhydroxyhydrocinnamate. In an even further aspect, the hindered phenol comprises octadecyl-3-(3,5-di-t-butyl-4-hydroxyphenyl)-propionate.

In a further aspect, the secondary anti-oxidant is selected from an organophosphate and thioester, or a combination thereof. In a still further aspect, the secondary anti-oxidant comprises one or more compounds selected from tetrakis(2,4-di-tert-butylphenyl) [1,1-biphenyl]-4,4′-diylbisphosphonite, tris(2,4-di-tert-butylphenyl)phosphite, bis(2,4-di-tert-butylphenyl)pentaerythritol diphosphite, bis(2,4-dicumylphenyl)pentaerytritoldiphosphite, tris(nonyl phenyl)phosphite, and distearyl pentaerythritol diphosphite. In yet a further aspect, the secondary anti-oxidant comprises tris(2,4-di-tert-butylphenyl)phosphite.

Antioxidants are generally used in amounts of about 0.01 wt % to about 3 wt %, optionally about 0.05 wt % to about 2.0 wt % of the blended thermoplastic composition.

In a further aspect, the primary antioxidant is present in an amount from about 0.01 wt % to about 3 wt %. In another aspect, the primary antioxidant is present in an amount from about 0.01 wt % to about 2.5 wt %. In still another aspect, the primary antioxidant is present in an amount from about 0.5 wt % to about 2.5 wt %. In yet a further aspect, the primary antioxidant is present in an amount from about 0.5 wt % to about 2.0 wt %. In still another aspect, the primary antioxidant is present in an amount from about 0.1 wt % to about 0.5 wt %. In still another aspect, the primary antioxidant is present in an amount from about 0.2 wt % to about 0.5 wt %. In still another aspect, the primary antioxidant is present in an amount from about 0.2 wt % to about 0.4 wt %.

In a further aspect, the secondary antioxidant is present in an amount from about 0.01 wt % to about 3.0 wt %. In another aspect, the secondary antioxidant is present in an amount from about 0.01 wt % to about 2.5 wt %. In still another aspect, the secondary antioxidant is present in an amount from about 0.5 wt % to about 2.5 wt %. In yet another aspect, the secondary antioxidant is present in an amount from about 0.5 wt % to about 2.0 wt %. In still another aspect, the secondary antioxidant is present in an amount from about 0.05 wt % to about 0.4 wt %. In still another aspect, the secondary antioxidant is present in an amount from about 0.05 wt % to about 0.2 wt %.

In various aspects, the disclosed blended thermoplastic compositions further comprise a hydrolytic stabilizer, wherein the hydrolytic stabilizer comprises a hydrotalcite and an inorganic buffer salt. In a further aspect, the disclosed polycarbonate blend composition comprises a hydrolytic stabilizer, wherein the hydrolytic stabilizer comprises one or more hydrotalcites and an inorganic buffer salt comprising one or more inorganic salts capable of pH buffering. Either synthetic hydrotalcites or natural hydrotalcites can be used as the hydrotalcite compound in the present invention. Exemplary hydrotalcites that are useful in the compositions of the present are commercially available and include, but are not limited to, magnesium hydrotalcites such as DHT-4C (available from Kyowa Chemical Co.); Hysafe 539 and Hysafe 530 (available from J.M. Huber Corporation).

In a further aspect, suitable thermal stabilizer additives include, for example, organic phosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, organic phosphates such as trimethyl phosphate, thioesters such as pentaerythritol betalaurylthiopropionate, and the like, or combinations comprising at least one of the foregoing thermal stabilizers.

Thermal stabilizers are generally used in amounts of about 0.01 wt % to about 5 wt %, optionally about 0.05 wt % to about 2.0 wt % of the polycarbonate blend composition. In one aspect, the thermal stabilizer is present in an amount from about 0.01 wt % to about 3.0 wt %. In another aspect, the thermal stabilizer is present in an amount from about 0.01 wt % to about 2.5 wt %. In still another aspect, the thermal stabilizer is present in an amount from about 0.5 wt % to about 2.5 wt %. In still another aspect, the thermal stabilizer is present in an amount from about 0.5 wt % to about 2.0 wt %. In still another aspect, the thermal stabilizer is present in an amount from about 0.1 wt % to about 0.8 wt %. In still another aspect, the thermal stabilizer is present in an amount from about 0.1 wt % to about 0.7 wt %. In still another aspect, the thermal stabilizer is present in an amount from about 0.1 wt % to about 0.6 wt %. In still another aspect, the thermal stabilizer is present in an amount from about 0.1 wt % to about 0.5 wt %. In still another aspect, the thermal stabilizer is present in an amount from about 0.1 wt % to about 0.4 wt %. In still another aspect, the thermal stabilizer is present in an amount from about 0.05 wt % to about 1.0 wt %.

In various aspects, plasticizers, lubricants, and/or mold release agents additives can also be used. There is a considerable overlap among these types of materials, which include, for example, phthalic acid esters such as dioctyl-4,5-epoxy-hexahydrophthalate; tris(octoxycarbonylethyl)isocyanurate; tristearin; di- or polyfunctional aromatic phosphates such as resorcinol tetraphenyl diphosphate (RDP), the bis(diphenyl)phosphate of hydroquinone and the bis(diphenyl)phosphate of bisphenol-A; poly-alpha-olefins; epoxidized soybean oil; silicones, including silicone oils; esters, for example, fatty acid esters such as alkyl stearyl esters, e.g. methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof; waxes such as beeswax, montan wax, paraffin wax or the like.

Blended thermoplastic composition additives such as plasticizers, lubricants, and/or mold release agents additive are generally used in amounts of about 0.01 wt % to about 20 wt %, optionally about 0.5 wt % to about 10 wt % the polycarbonate blend composition. In one aspect, the mold release agent is methyl stearate; stearyl stearate or pentaerythritol tetrastearate. In another aspect, the mold release agent is pentaerythritol tetrastearate.

In various aspects, the mold release agent is present in an amount from about 0.01 wt % to about 3.0 wt %. In another aspect, the mold release agent is present in an amount from about 0.01 wt % to about 2.5 wt %. In still another aspect, the mold release agent is present in an amount from about 0.5 wt % to about 2.5 wt %. In still another aspect, the mold release agent is present in an amount from about 0.5 wt % to about 2.0 wt %. In still another aspect, the mold release agent is present in an amount from about 0.1 wt % to about 0.6 wt %. In still another aspect, the mold release agent is present in an amount from about 0.1 wt % to about 0.5 wt %.

In a further aspect, the anti-drip agents can also be present. In a further aspect, the anti-drip agent is a styrene-acrylonitrile copolymer encapsulated polytetrafluoroethylene. Exemplary anti-drip agents can include a fibril forming or non-fibril forming fluoropolymer such as polytetrafluoroethylene (PTFE). The anti-drip agent can optionally be encapsulated by a rigid copolymer, for example styrene-acrylonitrile (SAN). PTFE encapsulated in SAN is known as TSAN. Encapsulated fluoropolymers can be made by polymerizing the encapsulating polymer in the presence of the fluoropolymer, for example, in an aqueous dispersion. TSAN can provide significant advantages over PTFE, in that TSAN can be more readily dispersed in the composition. A suitable TSAN can comprise, for example, about 50 wt % PTFE and about 50 wt % SAN, based on the total weight of the encapsulated fluoropolymer. Alternatively, the fluoropolymer can be pre-blended in some manner with a second polymer, such as for, example, an aromatic polycarbonate resin or SAN to form an agglomerated material for use as an anti-drip agent. Either method can be used to produce an encapsulated fluoropolymer.

In a further aspect, the anti-drip agent is present in an amount from about 0.01 wt % to about 3 wt %. In a still further aspect, the anti-drip agent is present in an amount from about 0.01 wt % to about 2.5 wt %. In yet a further aspect, the anti-drip agent is present in an amount from about 0.5 wt % to about 2.0 wt %.

In various aspects, the blended thermoplastic compositions of the present invention can further comprise an acid or an acid salt. In one embodiment, the acid or acid salt is an inorganic acid or inorganic acid salt. In one embodiment, the acid is an acid including a phosphorous containing oxy-acid. In one embodiment, the phosphorous containing oxy-acid is a multi-protic phosphorus containing oxy-acid having the general formula:

HₘPₜOₙ,

where m and n are each 2 or greater and t is 1 or greater. Examples of the acids of the foregoing formula include, but are not limited to, acids represented by the following formulas: H₃PO₄, H₃PO₃, and H₃PO₂. Other exemplary acids include phosphoric acid, phosphorous acid, hypophosphorous acid, hypophosphoric acid, phosphinic acid, phosphonic acid, metaphosphoric acid, hexametaphosphoric acid, thiophosphoric acid, fluorophosphoric acid, difluorophosphoric acid, fluorophosphorous acid, difluorophosphorous acid, fluorohypophosphorous acid, or fluorohypophosphoric acid. Alternatively, acids and acid salts, such as, for example, sulphuric acid, sulphites, mono zinc phosphate, mono calcium phosphate, sodium acid pyrophosphate, mono natrium phosphate, and the like, can be used.

### Methods of Manufacture

The blended thermoplastic compositions of the present invention can be blended with the aforementioned ingredients by a variety of methods involving intimate admixing of the materials with any additional additives desired in the formulation. Because of the availability of melt blending equipment in commercial polymer processing facilities, melt processing methods are generally preferred. Illustrative examples of equipment used in such melt processing methods include: co-rotating and counter-rotating extruders, single screw extruders, co-kneaders, disc-pack processors and various other types of extrusion equipment. The temperature of the melt in the present process is preferably minimized in order to avoid excessive degradation of the resins. It is often desirable to maintain the melt temperature between about 230° C. and about 350° C. in the molten resin composition, although higher temperatures can be used provided that the residence time of the resin in the processing equipment is kept short. In some embodiments the melt processed composition exits processing equipment such as an extruder through small exit holes in a die. The resulting strands of molten resin are cooled by passing the strands through a water bath. The cooled strands can be chopped into small pellets for packaging and further handling.

Compositions can be manufactured by various methods, including batch or continuous techniques that employ kneaders, extruders, mixers, and the like. For example, the composition can be formed as a melt blend employing a twin-screw extruder. In some embodiments at least some of the components are added sequentially. For example, the polycarbonate component and the impact modifier component, can be added to the extruder at the feed throat or in feeding sections adjacent to the feed throat, or in feeding sections adjacent to the feed throat, while the flame retardant component can be added to the extruder in a subsequent feeding section downstream. Alternatively, the sequential addition of the components may be accomplished through multiple extrusions. A composition may be made by preextrusion of selected components, such as the polycarbonate component and the impact modifier component to produce a pelletized mixture. A second extrusion can then be employed to combine the preextruded components with the remaining components. The flame retardant component can be added as part of a masterbatch or directly. The extruder can be a two lobe or three lobe twin screw extruder

In various aspects, the polycarbonate polymer, impact modifier component, the flame retardant component, the filler component and/or other optional components are first blended in a HENSCHEL-Mixer® high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat and/or downstream through a sidestuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate can be one-fourth inch long or less as desired. Such pellets can be used for subsequent molding, shaping, or forming.

In one aspect, the invention relates to methods of a preparing a composition, comprising the step of combining: (a) from about 30 wt % to about 90 wt % of a polycarbonate component; (b) from greater than about 0 wt % to about 15 wt % of an impact modifier component; and (c) from about 5 wt % to about 15 wt % of a flame retardant component comprising an oligomeric phosphate ester, wherein the oligomeric phosphate ester is a free flowing powder at 23° C.; wherein the combined weight percent value of all components does not exceed about 100 wt %; and wherein all weight percent values are based on the total weight of the composition.

In another aspect, the invention relates to methods of a preparing a composition, comprising the step of combining: (a) from about 30 wt % to about 90 wt % of a polycarbonate component comprising at least one bisphenol A polycarbonate and at least one polycarbonate-polysiloxane copolymer; (b) from greater than about 0 wt % to about 15 wt % of an impact modifier component; and (c) from about 5 wt % to about 15 wt % of a flame retardant component comprising an oligomeric phosphate ester, wherein the oligomeric phosphate ester is a free flowing powder at 23° C.; wherein the combined weight percent value of all components does not exceed about 100 wt %; and wherein all weight percent values are based on the total weight of the composition.

In a further aspect, combining comprises the steps of: (a) pre-blending from about 30 wt % to about 90 wt % of a polycarbonate component with from about 5 wt % to about 15 wt % of a flame retardant component to provide a pre-blended polycarbonate polymer and flame retardant; (b) feeding the pre-blended polycarbonate polymer and flame retardant into an extruder apparatus; and (c) compounding in the extruder apparatus the pre-blended polycarbonate polymer and flame retardant with from greater than about 0 wt % to about 15 wt % of an impact modifier component.

In a further aspect, combining comprises the steps of: (a) pre-blending from about 30 wt % to about 80 wt % of a polycarbonate component with from about 5 wt % to about 15 wt % of a flame retardant component to provide a pre-blended polycarbonate polymer and flame retardant; (b) feeding the pre-blended polycarbonate polymer and flame retardant into an extruder apparatus; and (c) compounding in the extruder apparatus the pre-blended polycarbonate polymer and flame retardant with from greater than about 0 wt % to about 15 wt % of an impact modifier component.

In one aspect, the invention relates to methods of a preparing a composition, comprising the step of mixing: (a) from about 20 wt % to about 60 wt % of a first polycarbonate component; wherein the first polycarbonate polymer component has a melt flow rate (MFR) from about 20 grams/10 minutes to about 30 grams/10 minutes when measured at 300° C. and under a load of 1.2 kg according to ASTM D1238; and wherein the first polycarbonate polymer component has a weight average molecular weight from about 18,000 to about 25,000 grams/mole, as measured by gel permeation chromatography using BPA polycarbonate standards; (b) from about 10 wt % to about 40 wt % of a second polycarbonate component; wherein the second polycarbonate polymer component has a melt flow rate (MFR) from about 4.0 grams/10 minutes to about 10.0 grams/10 minutes when measured at 300° C. and under a load of 1.2 kg according to ASTM D1238; and wherein the second polycarbonate polymer component has a weight average molecular weight from about 25,000 to about 30,000 grams/mole, as measured by gel permeation chromatography using BPA polycarbonate standards; (c) from about 1 wt % to about 25 wt % of a third polycarbonate component; wherein the third polycarbonate component is a polycarbonate-polysiloxane copolymer; wherein the third polycarbonate component comprises a polysiloxane block from about 15 wt % to about 30 wt % of the polycarbonate-polysiloxane copolymer; (d) from greater than about 0 wt % to about 15 wt % of an impact modifier component; and (e) from about 5 wt % to about 15 wt % of a flame retardant component; wherein the combined weight percent value of all components does not exceed about 100 wt %; and wherein all weight percent values are based on the total weight of the composition.

In another aspect, the invention relates to methods of a preparing a composition, comprising the step of mixing: (a) from about 20 wt % to about 60 wt % of a first polycarbonate component; wherein the first polycarbonate polymer component has a melt flow rate (MFR) from about 20 grams/10 minutes to about 30 grams/10 minutes when measured at 300° C. and under a load of 1.2 kg according to ASTM D1238; and wherein the first polycarbonate polymer component has a weight average molecular weight from about 18,000 to about 25,000 grams/mole, as measured by gel permeation chromatography using BPA polycarbonate standards; (b) from about 10 wt % to about 40 wt % of a second polycarbonate component; wherein the second polycarbonate polymer component has a melt flow rate (MFR) from about 4.0 grams/10 minutes to about 10.0 grams/10 minutes when measured at 300° C. and under a load of 1.2 kg according to ASTM D1238; and wherein the second polycarbonate polymer component has a weight average molecular weight from about 25,000 to about 30,000 grams/mole, as measured by gel permeation chromatography using BPA polycarbonate standards; (c) from about 1 wt % to about 25 wt % of a third polycarbonate component; wherein the third polycarbonate component is a polycarbonate-polysiloxane copolymer; wherein the third polycarbonate component comprises a polysiloxane block from about 15 wt % to about 30 wt % of the polycarbonate-polysiloxane copolymer; (d) from greater than about 0 wt % to about 15 wt % of an impact modifier component; and (e) from about 5 wt % to about 15 wt % of a flame retardant component; wherein the combined weight percent value of all components does not exceed about 100 wt %; and wherein all weight percent values are based on the total weight of the composition.

In a further aspect, mixing comprises the steps of: (a) pre-blending: (i) from about 20 wt % to about 60 wt % of a first polycarbonate component; (ii) from about 10 wt % to about 40 wt % of a second polycarbonate component; (iii) from about 1 wt % to about 25 wt % of a third polycarbonate component; and (iv) from about 5 wt % to about 15 wt % of a flame retardant component; thereby providing a pre-blended polycarbonate polymer and flame retardant; (b) feeding the pre-blended polycarbonate polymer and flame retardant into an extruder apparatus; and (c) compounding in the extruder apparatus the pre-blended polycarbonate polymer and flame retardant with from greater than about 0 wt % to about 15 wt % of an impact modifier component.

In a further aspect, mixing comprises the steps of: (a) pre-blending: (i) from about 20 wt % to about 60 wt % of a first polycarbonate component; (ii) from about 10 wt % to about 40 wt % of a second polycarbonate component; (iii) from about 1 wt % to about 25 wt % of a third polycarbonate component; and (iv) from about 5 wt % to about 15 wt % of a flame retardant component; thereby providing a pre-blended polycarbonate polymer and flame retardant; (b) feeding the pre-blended polycarbonate polymer and flame retardant into an extruder apparatus; and (c) compounding in the extruder apparatus the pre-blended polycarbonate polymer and flame retardant with from greater than about 0 wt % to about 15 wt % of an impact modifier component.

In a further aspect, mixing comprises the steps of: (a) pre-blending: (i) from about 20 wt % to about 40 wt % of a first polycarbonate component; (ii) from about 20 wt % to about 40 wt % of a second polycarbonate component; (iii) from about 5 wt % to about 15 wt % of a third polycarbonate component; and (iv) from about 5 wt % to about 15 wt % of a flame retardant component; thereby providing a pre-blended polycarbonate polymer and flame retardant; (b) feeding the pre-blended polycarbonate polymer and flame retardant into an extruder apparatus; and (c) compounding in the extruder apparatus the pre-blended polycarbonate polymer and flame retardant with from greater than about 0 wt % to about 5 wt % of an impact modifier component.

### Articles of Manufacture

In one aspect, the present invention pertains to shaped, formed, or molded articles comprising the blended thermoplastic compositions. The blended thermoplastic compositions can be molded into useful shaped articles by a variety of means such as injection molding, extrusion, rotational molding, blow molding and thermoforming to form articles. The blended thermoplastic compositions described herein can also be made into film and sheet as well as components of laminate systems. In a further aspect, a method of manufacturing an article comprises melt blending the polycarbonate component, the impact modifier component, the flame retardant component, and the filler component; and molding the extruded composition into an article. In a still further aspect, the extruding is done with a twin-screw extruder.

In a further aspect, the article is extrusion molded. In a still further aspect, the article is injection molded.

Formed articles include, for example, personal computers, notebook and portable computers, cell phone antennas and other such communications equipment, medical applications, RFID applications, automotive applications, and the like. In various further aspects, the article is a computer and business machine housing such as a housing for high end laptop personal computers, monitors, a hand held electronic device housing such as a housing for smart phones, tablets, music devices electrical connectors, and components of lighting fixtures, ornaments, home appliances, and the like.

In a further aspect, the present invention pertains to electrical or electronic devices comprising the disclosed blended polycarbonate compositions. In a further aspect, the electrical or electronic device comprising the disclosed blended polycarbonate compositions is a cellphone, a MP3 player, a computer, a laptop, a camera, a video recorder, an electronic tablet, a pager, a hand receiver, a video game, a calculator, a wireless car entry device, an automotive part, a filter housing, a luggage cart, an office chair, a kitchen appliance, an electrical housing, an electrical connector, a lighting fixture, a light emitting diode, an electrical part, or a telecommunications part.

In various aspects, the polymer composition can be used in the field of electronics. In a further aspect, non-limiting examples of fields which can use the disclosed blended thermoplastic polymer compositions include electrical, electro-mechanical, radio frequency (RF) technology, telecommunication, automotive, aviation, medical, sensor, military, and security. In a still further aspect, the use of the disclosed blended thermoplastic polymer compositions can also be present in overlapping fields, for example in mechatronic systems that integrate mechanical and electrical properties which may, for example, be used in automotive or medical engineering.

In a further aspect, the article is an electronic device, automotive device, telecommunication device, medical device, security device, or mechatronic device. In a still further aspect, the article is selected from a computer device, electromagnetic interference device, printed circuit, Wi-Fi device, Bluetooth device, GPS device, cellular antenna device, smart phone device, automotive device, medical device, sensor device, security device, shielding device, RF antenna device, LED device, and RFID device. In yet a further aspect, the article is selected from a computer device, sensor device, security device, RF antenna device, LED device and RFID device. In an even further aspect, the article is selected from a computer device, RF antenna device, LED device and RFID device. In a still further aspect, the article is selected from a RF antenna device, LED device and RFID device. In yet a further aspect, the article is selected from a RF antenna device and RFID device. In an even further aspect, the article is a LED device. In a still further aspect, the LED device is selected from a LED tube, a LED socket, and a LED heat sink.

In various aspects, molded articles according to the present invention can be used to produce a device in one or more of the foregoing fields. In a still further aspect, non-limiting examples of such devices in these fields which can use the disclosed blended thermoplastic polymer compositions according to the present invention include computer devices, household appliances, decoration devices, electromagnetic interference devices, printed circuits, Wi-Fi devices, Bluetooth devices, GPS devices, cellular antenna devices, smart phone devices, automotive devices, military devices, aerospace devices, medical devices, such as hearing aids, sensor devices, security devices, shielding devices, RF antenna devices, or RFID devices.

In a further aspect, the molded articles can be used to manufacture devices in the automotive field. In a still further aspect, non-limiting examples of such devices in the automotive field which can use the disclosed blended thermoplastic compositions in the vehicle's interior include adaptive cruise control, headlight sensors, windshield wiper sensors, and door/window switches. In a further aspect, non-limiting examples of devices in the automotive field which can the disclosed blended thermoplastic compositions in the vehicle's exterior include pressure and flow sensors for engine management, air conditioning, crash detection, and exterior lighting fixtures.

In a further aspect, the resulting disclosed compositions can be used to provide any desired shaped, formed, or molded articles. For example, the disclosed compositions can be molded into useful shaped articles by a variety of means such as injection molding, extrusion, rotational molding, blow molding and thermoforming. As noted above, the disclosed compositions are particularly well suited for use in the manufacture of electronic components and devices. As such, according to some aspects, the disclosed compositions can be used to form articles such as printed circuit board carriers, burn in test sockets, flex brackets for hard disk drives, and the like.

### Aspects

In various aspects, the present invention pertains to and includes at least the following aspects.

Aspect 1: A blended thermoplastic composition comprising:

a) from about 30 wt % to about 90 wt % of a polycarbonate component comprising at least one bisphenol A polycarbonate and at least one polycarbonate-polysiloxane copolymer;
b) from greater than about 0 wt % to about 20 wt % of an impact modifier component; and
c) from about 5 wt % to about 15 wt % of a flame retardant component comprising an oligomeric phosphate ester, wherein the oligomeric phosphate ester is a free flowing powder at 23° C.;
wherein the combined weight percent value of all components does not exceed about 100 wt %; and wherein all weight percent values are based on the total weight of the composition.

Aspect 2: The composition of aspect 1, wherein bisphenol A polycarbonate is a homopolymer comprising repeating units derived from bisphenol A.

Aspect 3: The composition of any of aspects 1-2, wherein the polycarbonate has a weight average molecular weight from about 18,000 to about 40,000 grams/mole, as measured by gel permeation chromatography using BPA polycarbonate standards.

Aspect 4: The composition of any of aspects 1-3, wherein the polycarbonate component comprises a blend of at least two polycarbonate polymers.

Aspect 5: The composition of any of aspects 1-4, wherein the polycarbonate component comprises a first polycarbonate polymer component and a second polycarbonate polymer component.

Aspect 6: The composition of aspect 5, wherein the first polycarbonate polymer component is a high flow polycarbonate.

Aspect 7: The composition of aspects 5 or 6, wherein the first polycarbonate polymer component has a melt flow rate (MFR) from about 20 grams/10 minutes to about 30 grams/10 minutes when measured at 300° C. and under a load of 1.2 kg according to ASTM D1238.

Aspect 8: The composition of any of aspects 5-7, wherein the first polycarbonate polymer component has a weight average molecular weight from about 18,000 to about 23,000 grams/mole, as measured by gel permeation chromatography using BPA polycarbonate standards.

Aspect 9: The composition of aspect 5, wherein the second polycarbonate polymer component is a low flow polycarbonate.

Aspect 10: The composition of aspects 5 or 9, wherein the second polycarbonate polymer component has a melt flow rate (MFR) from about 4.0 grams/10 minutes to about 10.0 grams/10 minutes when measured at 300° C. and under a load of 1.2 kg according to ASTM D1238.

Aspect 11: The composition of any of aspects 5 or 9-10, wherein the second polycarbonate polymer component has a weight average molecular weight from about 25,000 to about 30,000 grams/mole, as measured by gel permeation chromatography using BPA polycarbonate standards.

Aspect 12: The composition of aspect 5-11, wherein the first polycarbonate component is present in an amount from about 20 wt % to about 70 wt %; and wherein the second polycarbonate component is present in an amount from about 5 wt % to about 40 wt %.

Aspect 13: The composition of aspect 5-12, further comprising a third polycarbonate polymer component.

Aspect 14: The composition of aspect 13, wherein the third polycarbonate polymer component is the polycarbonate-polysiloxane copolymer.

Aspect 15: The composition of aspects 13 or 14, wherein the polycarbonate-polysiloxane copolymer is a block copolymer.

Aspect 16: The composition of aspect 15, wherein the polycarbonate block comprises residues derived from BPA.

Aspect 17: The composition of aspects 15 or 16, wherein the polycarbonate block comprising residues derived from BPA is a homopolymer.

Aspect 18: The composition of any of aspects 15-17, wherein the copolymer comprises dimethylsiloxane repeating units.

Aspect 19: The composition of any of aspects 15-18, wherein the copolymer comprises a polysiloxane block from about 18 wt % to about 24 wt % of the polycarbonate-polysiloxane copolymer.

Aspect 20: The composition of any of aspects 15-19, wherein the first polycarbonate component is present in an amount from about 20 wt % to about 70 wt %; wherein the second polycarbonate component is present in an amount from about 5 wt % to about 40 wt %; and wherein the third polycarbonate component is present in an amount from about 1 wt % to about 20 wt %.

Aspect 21: The composition of any of aspects 1-20, wherein the impact modifier component comprises at least one acrylonitrile-butadiene-styrene (ABS) polymer component, at least one methyl methacrylate-butadiene-styrene (MBS) polymer component, at least one methyl methacrylate-butadiene (MB) polymer component, or combinations thereof.

Aspect 22: The composition of aspect 21, wherein the impact modifier component comprises a methacrylate-butadiene-styrene (MBS) polymer component.

Aspect 23: The composition of aspects 21 or 22, wherein the MBS polymer component is present in an amount from about 1 wt % to about 5 wt %.

Aspect 24: The composition of any of aspects 21-23, wherein the polybutadiene content of the MBS polymer component is from about 60 wt % to about 80 wt % based on the weight of the MBS polymer.

Aspect 25: The composition of aspect 21, wherein the impact modifier component comprises an acrylonitrile-butadiene-styrene (ABS) polymer component.

Aspect 26: The composition of aspects 21 or 25, wherein the ABS polymer component is an emulsion polymerized ABS.

Aspect 27: The composition of aspects 21 or 25, wherein the ABS polymer component is a bulk-polymerized ABS.

Aspect 28: The composition of aspects 21 or 25, wherein the ABS polymer component is a SAN-grafted emulsion ABS.

Aspect 29: The composition of any of aspects 25-28, wherein the polybutadiene content of the ABS polymer component is from about 30 wt % to about 75 wt % based on the weight of the ABS polymer component.

Aspect 30: The composition of aspect 21, wherein the impact modifier component comprises a silicone rubber impact modifier (SRIM) polymer component.

Aspect 31: The composition of aspect 30, wherein the SRIM polymer component is present in an amount from greater than 0 wt % to about 5 wt %.

Aspect 32: The composition of any aspects 1-29, wherein the impact modifier is present is an amount from about 1 wt % to about 10 wt %.

.

Aspect 33: The composition aspect 1-30, wherein the flame retardant component is present in an amount from about 5 wt % to about 12 wt %.

Aspect 34: The composition of any aspects 1-33, further comprising at least one additive.

Aspect 35: The composition of aspect 34, wherein the additive is selected from an anti-drip agent, antioxidant, antistatic agent, chain extender, colorant, de-molding agent, dye, flow promoter, flow modifier, light stabilizer, lubricant, mold release agent, pigment, quenching agent, thermal stabilizer, UV absorbent substance, UV reflectant substance, and UV stabilizer, or combinations thereof.

Aspect 36: The composition of aspect 35, wherein the anti-drip agent is present in an amount from about 0.05 wt % to about 3 wt %.

Aspect 37: The composition of aspect 35, wherein the anti-drip agent is a styrene-acrylonitrile copolymer encapsulated polytetrafluoroethylene.

Aspect 38: The composition of aspect 35, wherein the antioxidant is a primary antioxidant, a secondary antioxidant, or combinations thereof.

Aspect 39: The composition of aspect 38, wherein the primary antioxidant is selected from a hindered phenol and secondary aryl amine, or a combination thereof.

Aspect 40: The composition of aspect 39, wherein the hindered phenol comprises one or more compounds selected from triethylene glycol bis[3-(3-t-butyl-5-methyl-4-hydroxyphenyl)propionate], 1,6-hexanediolbis[3-(3,5-di-t-butyl-4-hydroxyphenyl)propionate], 2,4-bis(n-octylthio)-6-(4-hydroxy-3,5-di-t-butylanilino)-1,3,5-triazine, pentaerythrityl tetrakis[3-(3,5-di-t-butyl-4-hydroxyphenyl)propionate], 2,2-thiodiethylene bis[3-(3,5-di-t-butyl-4-hydroxyphenyl)propionate], octadecyl 3-(3,5-di-t-butyl-4-hydroxyphenyl)propionate, N,N′-hexamethylene bis(3,5-di-t-butyl-4-hydroxy-hydrocinnamamide), tetrakis(methylene 3,5-di-tert-butyl-hydroxycinnamate)methane, and octadecyl 3,5-di-tert-butylhydroxyhydrocinnamate.

Aspect 41: The composition of aspect 38, wherein the primary anti-oxidant is present in an amount from about 0.01 wt % to about 0.50 wt %.

Aspect 42: The composition of aspect 38, wherein the secondary anti-oxidant is selected from an organophosphate and thioester, or a combination thereof.

Aspect 43: The composition of aspect 42, wherein the secondary anti-oxidant comprises one or more compounds selected from tetrakis(2,4-di-tert-butylphenyl) [1,1-biphenyl]-4,4′-diylbisphosphonite, tris(2,4-di-tert-butylphenyl)phosphite, bis(2,4-di-tert-butylphenyl)pentaerythritol diphosphite, bis(2,4-dicumylphenyl)pentaerytritoldiphosphite, tris(nonyl phenyl)phosphite, and distearyl pentaerythritol diphosphite.

Aspect 44: The composition of aspect 38, wherein the secondary anti-oxidant is present in an amount from about 0.01 wt % to about 0.50 wt %.

Aspect 45: The composition of any aspects 1-, wherein a molded sample comprising the blended thermoplastic composition has a notched Izod impact strength of at least about 500 Jim when tested in accordance with ASTM D256 at about −20° C.

Aspect 46: The composition of any aspects 1-45, wherein a molded sample comprising the blended thermoplastic composition has a p(FTP) value of at least about 0.90.

Aspect 47: The composition of any aspects 1-46, wherein a molded sample comprising the blended thermoplastic composition has 100% ductility notched Izod impact strength test conditions per ASTM D256 at about 0° C.

Aspect 48: The composition of any aspects 1-46, wherein a molded sample comprising the blended thermoplastic composition has 100% ductility notched Izod impact strength test conditions per ASTM D256 at about −20° C.

Aspect 49: A blended thermoplastic composition comprising:

a) from about 60 wt % to about 90 wt % of a polycarbonate component comprising at least one bisphenol A polycarbonate and at least one polycarbonate-polysiloxane copolymer;
b) from about 1 wt % to about 20 wt % of an impact modifier component; and
c) from about 5 wt % to about 12 wt % of a flame retardant component comprising an oligomeric phosphate ester, wherein the oligomeric phosphate ester is a free flowing powder at 23° C.;
wherein the combined weight percent value of all components does not exceed about 100 wt %; and wherein all weight percent values are based on the total weight of the composition.

Aspect 50: A blended thermoplastic composition comprising:

a) from about 60 wt % to about 90 wt % of a polycarbonate component comprising at least one bisphenol A polycarbonate and at least one polycarbonate-polysiloxane copolymer;
b) from about 1 wt % to about 10 wt % of an impact modifier component comprising at least one methyl methacrylate-butadiene-styrene (MBS) polymer component; and
c) from about 5 wt % to about 12 wt % of a flame retardant component comprising an oligomeric phosphate ester, wherein the oligomeric phosphate ester is a free flowing powder at 23° C.;
wherein the combined weight percent value of all components does not exceed about 100 wt %; and wherein all weight percent values are based on the total weight of the composition.

Aspect 51: A blended thermoplastic composition comprising:

a) from about 60 wt % to about 90 wt % of a polycarbonate component comprising at least one bisphenol A polycarbonate and at least one polycarbonate-polysiloxane copolymer;
b) from about 1 wt % to about 10 wt % of an impact modifier component at least one methyl methacrylate-butadiene (MB) polymer component; and
c) from about 6 wt % to about 11 wt % of a flame retardant component comprising an oligomeric phosphate ester, wherein the oligomeric phosphate ester is a free flowing powder at 23° C.;
wherein the combined weight percent value of all components does not exceed about 100 wt %; and wherein all weight percent values are based on the total weight of the composition.

Aspect 52: A blended thermoplastic composition comprising:

a) from about 40 wt % to about 60 wt % of a first polycarbonate component; wherein the first polycarbonate polymer component has a melt flow rate (MFR) from about 20 grams/10 minutes to about 30 grams/10 minutes when measured at 300° C. and under a load of 1.2 kg according to ASTM D1238; and wherein the first polycarbonate polymer component has a weight average molecular weight from about 18,000 to about 25,000 grams/mole, as measured by gel permeation chromatography using BPA polycarbonate standards;
b) from about 10 wt % to about 40 wt % of a second polycarbonate component; wherein the second polycarbonate polymer component has a melt flow rate (MFR) from about 4.0 grams/10 minutes to about 10.0 grams/10 minutes when measured at 300° C. and under a load of 1.2 kg according to ASTM D1238; and wherein the second polycarbonate polymer component has a weight average molecular weight from about 25,000 to about 30,000 grams/mole, as measured by gel permeation chromatography using BPA polycarbonate standards;
c) from about 5 wt % to about 20 wt % of a third polycarbonate component; wherein the third polycarbonate component is a polycarbonate-polysiloxane copolymer; wherein the third polycarbonate component comprises a polysiloxane block from about 5 wt % to about 30 wt % of the polycarbonate-polysiloxane copolymer;
d) from greater than about 0 wt % to about 20 wt % of an impact modifier component; and
e) from about 5 wt % to about 15 wt % of a flame retardant component comprising an oligomeric phosphate ester; wherein the oligomeric phosphate ester is a free flowing powder at 23° C.;
wherein the combined weight percent value of all components does not exceed about 100 wt %; and wherein all weight percent values are based on the total weight of the composition.

Aspect 53: A blended thermoplastic composition comprising:

a) from about 30 wt % to about 90 wt % of a polycarbonate component comprising at least one bisphenol A polycarbonate and at least one polycarbonate-polysiloxane copolymer;
b) from greater than about 0 wt % to about 10 wt % of an impact modifier component comprising at least one methyl methacrylate-butadiene-styrene (MBS) polymer component; and
c) from about 5 wt % to about 15 wt % of a flame retardant component comprising an oligomeric phosphate ester, wherein the oligomeric phosphate ester is a free flowing powder at 23° C.;
wherein the combined weight percent value of all components does not exceed about 100 wt %; wherein all weight percent values are based on the total weight of the composition; wherein a molded sample comprising the blended thermoplastic composition has a notched Izod impact strength of at least about 350 J/m when tested in accordance with ASTM D256 at −20° C.; wherein a molded sample comprising the blended thermoplastic composition has 100% ductility notched Izod impact strength when tested in accordance with ASTM D256 at −20° C.; and wherein a molded sample comprising the blended thermoplastic composition has a p(FTP) value of at least about 0.9.

Aspect 54: An article comprising the composition of any of aspects 1-53.

Aspect 55: The article of aspect 54, wherein the article is molded.

Aspect 56: The article of aspect 54, wherein the article is extrusion molded.

Aspect 57: The article of aspect 54, wherein the article is injection molded.

Aspect 58: The article of any of aspects 54-57, wherein the article is selected from a computer device, electromagnetic interference device, printed circuit, Wi-Fi device, Bluetooth device, GPS device, cellular antenna device, smart phone device, automotive device, medical device, sensor device, security device, shielding device, RF antenna device, LED device and RFID device.

Aspect 59: A method of preparing a composition, comprising the step of combining:

a) from about 30 wt % to about 90 wt % of a polycarbonate component comprising at least one bisphenol A polycarbonate and at least one polycarbonate-polysiloxane copolymer;
b) from greater than about 0 wt % to about 15 wt % of an impact modifier component; and
c) from about 5 wt % to about 15 wt % of a flame retardant component comprising an oligomeric phosphate ester, wherein the oligomeric phosphate ester is a free flowing powder at 23° C.;
wherein the combined weight percent value of all components does not exceed about 100 wt %; and wherein all weight percent values are based on the total weight of the composition.

Aspect 60: The method of aspect 59, wherein the step of combining comprises extrusion blending.

Aspect 61: The method of aspect 60, further comprising step of molding the thermoplastic polymer blend composition into a molded article.

Without further elaboration, it is believed that one skilled in the art can, using the description herein, utilize the present invention. The following examples are included to provide addition guidance to those skilled in the art of practicing the claimed invention. The examples provided are merely representative of the work and contribute to the teaching of the present invention. Accordingly, these examples are not intended to limit the invention in any manner.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %.

There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

The materials shown in Table 1 were used to prepare the compositions described and evaluated herein.

TABLE 1

| Component | Chemical description | Source |
|---|---|---|
| PC1 | BPA polycarbonate resin made by a melt process | SABIC Innovative |
| | with an MFR at 300° C./1.2 kg, of about 23.5 to | Plastics (“SABIC |
| | about 28.5 g/10 min. | I.P.”) |
| PC2 | BPA polycarbonate resin made by an interfacial | SABIC I.P. |
| | process with MFR at 300° C./1.2 kg, of about 5.1 to | |
| | about 6.9 g/10 min. | |
| EXL-PC | BPA polycarbonate-polydimethylsiloxane block | SABIC I.P. |
| | copolymer comprising about 20 wt % of siloxane | |
| | and about 80 wt % by of BPA; paracumyl phenol | |
| | (PCP) end-capped; with a polydiorganosiloxane | |
| | chain length of about 45 (D45) and having a Mw of | |
| | about 29,900 Daltons. | |
| ABS | Acrylonitrile-butadiene-styrene impact modifier | SABIC I.P. |
| | having acrylonitrile = 15 weight %, butadiene = 16 | |
| | weight percent and styrene = 69 weight percent. | |
| MB | Methyl methacrylate-butadiene core-shell type | Dow Chemical |
| | impact modifier made by Dow Chemical Co. and | Co. |
| | sold under the trade name EXL2650A. | |
| MBS | Methyl methacrylate-butadiene core-shell type | Dow Chemical |
| | impact modifier made by Dow Chemical Co. and | Co. |
| | sold under the trade name EXL2691A. | |
| SAN | Styrene-acrylonitrile copolymer with acrylonitrile = | SABIC I.P. |
| | 25% | |
| FR1 | Bisphenol A bis(diphenyl phosphate) | Adeka |
| | | Corporation |
| FR2 | Solid oligomeric phosphate ester; (free flowing | ICL-IP |
| | powder at 23° C.); commercially available under the | |
| | trade name Fyrolflex SolDP | |
| FR3 | Resorcinol tetraphenyl diphosphate (RDP) | ICL-IP |
| ADD1 (AO1) | Tris (2,4-di-tert-butylphenyl) phosphite; available | Great Lakes |
| | under the trade name Irgaphos ™ I-168. | Chemical Corp. |
| ADD2 (PETS) | Pentaerythritol tetrastearate | Faci Asia Pacific |
| | | Pte. Ltd. |
| ADD3 (AO2) | Sterically hindered phenol antioxidant, octadecyl-3- | Ciba Specialty |
| | (3,5-di-tert•butyl-4-hydroxyphenyl)-propionate | Chemicals, Ltd. |
| | (CAS# 2082-79-3); available under the trade name | |
| | Irganox ® 1076. | |
| ADD4 (TSAN) | Polytetrafluoroethylent (PTFE) encapsulated in | SABIC I.P. |
| | SAN (50 wt. % PTFE, 50 wt. % SAN). | |

All samples were prepared by melt extrusion on a Toshiba Twin screw extruder, using a nominal melt temperature of 265° C. and operated at 400 rpm.

Melt volume flow rate (“MVR”) was determined per the test method of ASTM D1238 under the following test conditions: 260° C./2.16 kg at a dwell time of 360 s (standard condition) and 1080 s (abusive condition). Data below are provided for MVR in cm³/10 min.

Notched izod impact (“NII”) tests were carried out on molded samples (bars) according to ASTM D256 at 23° C., 0° C., or −20° C. using a 5 lb hammer, respectively. Both impact strength (J/m) and ductility were determined.

Heat deflection temperature (“HDT”) was determined at 1.82 MPa on a samples with 6.4 mm thickness in accordance with ASTM D 648.

Flammability tests were performed following the procedure of Underwriter's Laboratory Bulletin 94 entitled “Tests for Flammability of Plastic Materials, UL94”, which is incorporated herein by reference. According to this procedure, the materials were classified as either UL94 V0, UL94 V1, or UL94 V2 on the basis of the test results obtained for five samples. The procedure and criteria for each of these flammability classifications according to UL94 are, briefly, as follows. Multiple specimens (20) are tested per thickness. Some specimens are tested after conditioning for 48 hours at 23° C., 50% relative humidity. The other specimens are tested after conditioning for 168 hours at 70° C. The bar is mounted with the long axis vertical for flammability testing. The specimen is supported such that its lower end is 9.5 mm above the Bunsen burner tube. A blue 19 mm high flame is applied to the center of the lower edge of the specimen for 10 seconds. The time until the flaming of the bar ceases is recorded (T1). If burning ceases, the flame is re-applied for an additional 10 seconds. Again, the time until the flaming of the bar ceases is recorded (T2). If the specimen drips particles, these shall be allowed to fall onto a layer of untreated surgical cotton placed 305 mm below the specimen.

V0: In a sample placed so that its long axis is 180 degrees to the flame, the maximum period of flaming and/or smoldering after removing the igniting flame does not exceed 10 seconds and none of the vertically placed samples produces drips of burning particles that ignite absorbent cotton, and no specimen burns up to the holding clamp after flame or after glow.

The data were also analyzed by calculating the average flame out time, standard deviation of the flame out time and the total number of drips, and by using statistical methods to convert that data to a prediction of the probability of first time pass, or “p(FTP)”, that a particular sample formulation would achieve a “pass” rating in the conventional UL94 V0 or V1 testing of 5 bars. The probability of a first time pass on a first submission p(FTP) may be determined according to the formula:

p(FTP)=(P_{t1>mbt,n=0}XP_{t2>mbt,n=0}XP_{total<=mtbt}XP_{drip,n=0})

where P_{t1>mbt,n=0} is the probability that no first burn time exceeds a maximum burn time value, P_{t2>mbt,n=0} is the probability that no second burn time exceeds a maximum burn time value, P_{total<=mtbt} is the probability that the sum of the burn times is less than or equal to a maximum total burn time value, and P_{drip,n=0} is the probability that no specimen exhibits dripping during the flame test. First and second burn time refer to burn times after a first and second application of the flame, respectively.

The probability that no first burn time exceeds a maximum burn time value, P_{t1>mbt,n=0}, may be determined the formula:

P_{t1>mbt,n=0}=(1−P_{t1>mbt})⁵

where P_{t1>mbt} is the area under the log normal distribution curve for t1>mbt, and where the exponent “5” relates to the number of bars tested. The probability that no second burn time exceeds a maximum burn time value may be determined from the formula:

P_{t2>mbt,n=0}=(1−P_{t2>mbt})

where P_{t2>mbt} is the area under the normal distribution curve for t2>mbt. As above, the mean and standard deviation of the burn time data set are used to calculate the normal distribution curve. For the UL-94 V0 rating, the maximum burn time is 10 seconds. For a V1 or V2 rating the maximum burn time is 30 seconds. The probability P_{drip,n=-0} that no specimen exhibits dripping during the flame test is an attribute function, estimated by:

P_{drip,n=0}=(1−P_{drip})⁵

where P_{drip}=(the number of bars that drip/the number of bars tested).

The probability P_{total<=mtbt} that the sum of the burn times is less than or equal to a maximum total burn time value may be determined from a normal distribution curve of simulated 5-bar total burn times. The distribution may be generated from a Monte Carlo simulation of 1000 sets of five bars using the distribution for the burn time data determined above. Techniques for Monte Carlo simulation are well known in the art. A normal distribution curve for 5-bar total burn times may be generated using the mean and standard deviation of the simulated 1000 sets. Therefore, P_{total<=mtbt} may be determined from the area under a log normal distribution curve of a set of 1000 Monte Carlo simulated 5-bar total burn time for total≦maximum total burn time. For the UL-94 V0 rating, the maximum total burn time is 50 seconds. For a VI or V2 rating, the maximum total burn time is 250 seconds.

### Example 1

A series of blended polycarbonate compositions were prepared as set forth in Table 2 below, using the materials described above in Table 1, wherein all amounts are given in wt %. The compositions of Table 2 were tested for melt volume flow rate, heat deflection temperature, notched izod impact strength and % ductility, multi-axial impact strength and ductility, and flammability. Data for performance of the formulations in the various tests are shown in Table 3.

Sample 1 is the control sample which comprises 10% FR1 and no FR2. In contrast, Samples 2 and 3 contain 10% and 8.32% FR2 respectively. Given, FR1 contains 8.9% phosphorous, and FR2 contains 10.7% phosphorous, 10 wt % FR1 contains the same phosphorous as a 8.32 wt % FR2. Thus, Sample 1 and Sample 3 contain an equal phosphorous content.

TABLE 2

| No. | Item | Sample 1 | Sample 2 | Sample 3 |
|---|---|---|---|---|
| 1 | PC1 | 65.8 | 65.8 | 65.8 |
| 2 | PC2 | 5.7 | 5.7 | 5.7 |
| 3 | EXL-PC | 14 | 14 | 14 |
| 4 | FR1 | 10 | — | — |
| 5 | FR2 | — | 10 | 8.32 |
| 6 | ABS | 3 | 3 | 3 |
| 7 | ADD1 | 0.08 | 0.08 | 0.08 |
| 8 | ADD2 | 0.3 | 0.3 | 0.3 |
| 9 | ADD3 | 0.08 | 0.08 | 0.08 |
| 10 | ADD4 | 1.0 | 1.0 | 1.0 |

| | | | |
|---|---|---|---|
| Formulation Total | 100 | 100 | 100 |

As seen in Table 3, the data indicate a slight increase in impact strength at room temperature. However, all these formulations had 0% notched Izod ductility at 0° C., and therefore, would be unsuitable for applications that might require notched Izod ductility at 0° C. The flame performance for all the three samples was measured to be V-0 at 0.6 mm as indicated by p(FTP) values.

TABLE 3

| | | Sample | Sample | Sample |
|---|---|---|---|---|
| Test* | Unit | 1 | 2 | 3 |
| MVR (260° C./2.16 kg/360 s) | cm³/10 min | 17.2 | 19.3 | 17.2 |
| HDT (1.8 MPa/6.4 mm) | ° C. | 92 | 90 | 97 |
| NII - Impact Strength (23° C.) | J/m | 546 | 676 | 762 |
| NII - Ductility (23° C.) | % | 80 | 100 | 100 |
| NII - Impact Strength (0° C.) | J/m | 94 | 97 | 124 |
| NII - Ductility (0° C.) | % | 0 | 0 | 0 |
| UL94 - Vertical flame test | p(FTP), V0 | 1.0 | 1.0 | 1.0 |
| (0.6 mm/23° C./48 h) | | | | |
| UL94 - Vertical flame test | p(FTP), V0 | 1.0 | 1.0 | 1.0 |
| (0.6 mm/70° C./168 h) | | | | |

*Carried out as described herein;

### Example 2

Additional polycarbonate formulations were prepared as set forth in Table 4 below, using the materials described above in Table 1. Sample 4, containing 10.5 wt % FR1, is the control sample. Sample 5 contains 8.73 wt % FR2, which contributes an equal phosphorous % to the Sample 5 formulation as FR1 does in the Sample 4 formulation. These formulations are based on MB as the impact modifier. The properties of the these formulations are reported in Table 5.

TABLE 4

| No. | Item | Sample 4 | Sample 5 |
|---|---|---|---|
| 1 | PC1 | 53.0 | 54.3 |
| 2 | PC2 | 17.6 | 18.1 |
| 3 | EXL-PC | 16 | 16 |
| 4 | FR1 | 10.5 | — |
| 5 | FR2 | — | 8.73 |
| 6 | MB | 2 | 2 |
| 7 | ADD1 | 0.08 | 0.08 |
| 8 | ADD2 | 0.3 | 0.3 |
| 9 | ADD3 | 0.1 | 0.1 |
| 10 | ADD4 | 0.4 | 0.4 |

| | | |
|---|---|---|
| Formulation Total | 100 | 100 |

Again, an improvement in impact strength at 23° C. and 0° C. was observed when FR2 was substituted for FR1. However, in this case, the data indicate that the presence of MBS allows both the FR1-containing formulation and the FR2-containing formulations to be 100% ductile and have high impact strength at 23° C. and at 0° C. For example, in contrast to the Example 2 formulations, none of the formulations in Example 1 had ductility at 0° C., indicating that the substitution of MBS for Bulk ABS was responsible for the improved ductility at 0° C. However, as seen in Table 5, only FR2-containing formulations exhibited notched Izod ductility at −20° C., whereas the FR1-containing sample exhibited no ductility, despite the use of MBS in the formulation. Without wishing to be bound by a particular theory, the use of FR2, in combination with MBS and EXL-PC, can result in formulations having ductility at lower temperatures that formulations containing FR1. As shown in Example 1, in the absense of the combination of a polycarbonate-polysiloxane and a specific impact modifier (i.e. MBS was not in the formulations), low temperature impact strength and ductility improvements are not observed. Thus, the data indicates that FR2 in combination with a polycarbonate-polysiloxane and MBS improves the low temperature ductility, which is otherwise not achieved with use of a polycarbonate-polysiloxane and MBS with another flame retardant. Moreover, the flame performance of the formulations remained substabtially the same when FR1 was replaced with FR2. The FR2-containing formulations were also observed to have excellent MAI impact down to the lowest measured temperature of −40° C.

TABLE 5

| Test* | Unit | Sample 4 | Sample 5 |
|---|---|---|---|
| MVR (260° C./2.16 kg/360 s) | cm³/10 min | 15.9 | 13.6 |
| HDT (1.8 MPa/6.4 mm) | ° C. | 95 | 95.6 |
| NII - Impact Strength (23° C.) | J/m | 744 | 877 |
| NII - Ductility (23° C.) | % | 100 | 100 |
| NII - Impact Strength (0° C.) | J/m | 580 | 745 |
| NII - Ductility (0° C.) | % | 100 | 100 |
| NII - Impact Strength (−20° C.) | J/m | 134 | 550 |
| NII - Ductility (−20° C.) | % | 0 | 100 |
| UL94 - Vertical flame test | p(FTP), V0 | 0.9 | 0.9 |
| (0.6 mm/23° C./48 h) | | | |
| UL94 - Vertical flame test | p(FTP), V0 | 1.0 | 1.0 |
| (0.6 mm/70° C./168 h) | | | |

*Carried out as described herein;

### Example 3

Plate out study was performed to evaluate outgassing and plating out performance. Two formulations were prepared as set forth in Table 6, each formulation being identical except Sample 6 contained 11% FR1 and Sample 7 contained 11% FR2. Briefly, for the plate out study, multiple shots are injected to partially fill a mold. At the end of the required number of shots, the mold is opened, the deposited material is then collected for examination. The result of this study showed that the plate out for the FR1-containing sample was 89 mg, whereas the plate out from the FR2-containing sample was only 62 mg. As the data show, the use of FR2 reduced the plating out in the flame retardant, impact modified PC blend, which in various aspects can make processing procedures, such as molding or extrusion, more efficient and productive as a result of decreased product rejects and less time required to clean the mold.

TABLE 6

| No. | Item | Sample 6 | Sample 7 |
|---|---|---|---|
| 1 | PC1 | 58.44 | 58.44 |
| 2 | PC2 | 16 | 16 |
| 3 | SAN | 6.45 | 6.45 |
| 4 | FR1 | 11 | |
| 5 | FR2 | | 11 |
| 6 | MBS | 6.5 | 6.5 |
| 7 | ADD1 | 0.08 | 0.08 |
| 8 | ADD2 | 0.3 | 0.3 |
| 9 | ADD3 | 0.08 | 0.08 |
| 10 | ADD4 | 0.65 | 0.65 |
| 11 | COL1 | 0.5 | 0.5 |

| | | |
|---|---|---|
| Formulation Total | 100 | 100 |

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A blended thermoplastic composition comprising:
a) from about 60 wt % to about 90 wt % of a polycarbonate component comprising at least one bisphenol A polycarbonate and at least one polycarbonate-polysiloxane copolymer;
b) from greater than 0 wt % to about 10 wt % of an impact modifier component comprising at least one of a methyl methacrylate-butadiene-styrene (MBS) polymer component or a methyl methacrylate-butadiene (MB) polymer component; and
c) from about 5 wt % to about 15 wt % of a flame retardant component comprising an oligomeric phosphate ester, wherein the oligomeric phosphate ester is a free flowing powder at 23° C.;
wherein a molded sample comprising the composition has 100% ductility notched Izod impact strength in accordance with ASTM D256 at about −30° C.;
wherein the combined weight percent value of all components does not exceed 100 wt %; and
wherein all weight percent values are based on the total weight of the composition.

2. The composition of claim 1, wherein bisphenol A polycarbonate is a homopolymer comprising repeating units derived from bisphenol A.

3. The composition of claim 1, wherein the polycarbonate has a weight average molecular weight from about 18,000 to about 40,000 grams/mole, as measured by gel permeation chromatography using BPA polycarbonate standards.

4. The composition of claim 1, wherein the polycarbonate component comprises a blend of at least two polycarbonate polymers.

5. The composition of claim 1, wherein the polycarbonate component comprises a first polycarbonate polymer component and a second polycarbonate polymer component.

6. The composition of claim 5, wherein the first polycarbonate polymer component is a high flow polycarbonate, and wherein the second polycarbonate polymer component is a low flow polycarbonate.

7. (canceled)

8. The composition of claim 5, further comprising a third polycarbonate polymer component.

9. The composition of claim 8, wherein the third polycarbonate polymer component is the polycarbonate-polysiloxane copolymer.

10. The composition of claim 8, wherein the polycarbonate-polysiloxane copolymer is a block copolymer.

11. The composition of claim 10, wherein the polycarbonate block comprises residues derived from BPA.

12. The composition of claim 10, wherein the copolymer comprises dimethylsiloxane repeating units.

13. The composition of claim 10, wherein the copolymer comprises a polysiloxane block from about 18 wt % to about 24 wt % of the polycarbonate-polysiloxane copolymer.

14. (canceled)

15. (canceled)

16. (canceled)

17. The composition of claim 1, wherein the MBS polymer component or MB polymer component is present in an amount from about 1 wt % to about 8 wt %.

18. (canceled)

19. (canceled)

20. The composition of claim 1, further comprising at least one additive.

21. The composition of claim 20, wherein the additive is selected from an anti-drip agent, antioxidant, antistatic agent, chain extender, colorant, de-molding agent, dye, flow promoter, flow modifier, light stabilizer, lubricant, mold release agent, pigment, quenching agent, thermal stabilizer, UV absorbent substance, UV reflectant substance, and UV stabilizer, or combinations thereof.

22. The composition of claim 1, wherein a molded sample comprising the composition has a notched Izod impact strength of at least about 200 J/m when tested in accordance with ASTM D256 at about −30° C.

23. The composition of claim 1, wherein a molded sample comprising the composition has a p(FTP) value of at least about 0.90.

24. (canceled)

25. (canceled)

26. (canceled)

27. (canceled)

28. An article comprising the composition of claim 1.

29. The article of claim 28, wherein the article is molded.

30. A method of preparing a composition, comprising the step of combining:
a) from about 60 wt % to about 90 wt % of a polycarbonate component comprising at least one bisphenol A polycarbonate and at least one polycarbonate-polysiloxane copolymer;
b) from greater than about 0 wt % to about 10 wt % of an impact modifier component comprising at least one of a methyl methacrylate-butadiene-styrene (MBS) polymer component or a methyl methacrylate-butadiene (MB) polymer component; and
c) from about 5 wt % to about 15 wt % of a flame retardant component comprising an oligomeric phosphate ester, wherein the oligomeric phosphate ester is a free flowing powder at 23° C.;
wherein a molded sample comprising the composition has 100% ductility notched Izod impact strength in accordance with ASTM D256 at about −30° C.;
wherein the combined weight percent value of all components does not exceed 100 wt %; and
wherein all weight percent values are based on the total weight of the composition.

31. The method of claim 30, wherein the step of combining comprises extrusion blending.

32. The method of claim 31, further comprising step of molding the composition into a molded article.
